(19) United States
(12) Patent Application Publication
(10) Pub. No.: US 2003/0182203 A1
(43) Pub. Date: Sep. 25, 2003

(54) Method for supporting shipment of virtual shopping mall

(76) Inventors: Takayasu Kumakawa, Kyoto (JP); Kazuya Yamazaki, Kyoto (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,901

(22) PCT Filed: Aug. 28, 2001
(86) PCT No.: PCT/JP01/07360

(30) Foreign Application Priority Data
Aug. 31, 2000 (JP) 2000-263089

(51) Int. Cl. G06F 17/60

(52) U.S. Cl. 705/26

(57) ABSTRACT

A shipment-supporting server 19 generates a shipping instruction pending list based on order information from an order-accepting server 15, and transmits the shipping instruction pending list to a shopkeeper terminal. The shopkeeper terminal 23 generates transport information, shipping-place information, and a shipping instruction request based on the received shipping instruction pending list, and transmits the transport information, the shipping-place information, and the shipping instruction request to the shipment-supporting server 19. Then, shipment-supporting server 19 generates a shipment pending list based on the transport information, the shipping-place information, and the shipping instruction request thus received, and transmits the shipment pending list to each shipping-place terminal 25. Moreover, the shipping-place terminal 25 displays the received shipment pending list, and transmits a request for shipping instruction information regarding this unshipped merchandise to the shipment-supporting server 19. Thereafter, the shipment-supporting server 19 generates a shipping instruction list and tag data in response to the received request for shipping instruction information, and transmits the shipping instruction list and the tag data to the shipping-place terminal 25. Furthermore, the shipping-place terminal 25 prints the received shipping instruction list and the tag data out of a printer 73.

### TECHNICAL FIELD

This invention relates to a shipment-supporting method for a virtual shopping mall, which supports shipment of merchandise by specifying a shipping place and allowing print of a shipping instruction list and a shipping tag at the shipping place in accordance with an order from a purchaser for the merchandise presented to a shop in a virtual shopping mall opened in a server on the Internet, for example.

### BACKGROUND ART

In a conventional shipment-supporting method for merchandise, an order from a purchaser for merchandise has been generally sent by use of a telephone, a postal mail, or a facsimile.

For example, a purchaser would produce an order form for merchandise and transmit this order form to an order-accepting center by use of a facsimile. The order-accepting center would put order forms thus accepted together into order data and transmit these order data to a section storing the merchandise such as a distribution center. Here, shipping lists would be produced depending on destinations (which do not always coincide with the purchasers) and printed out of a printer, and assembling operations would be performed for delivery by use of these shipping lists. Simultaneously, tag data would be produced out of the order data and then printed out to carbon copy paper set on the printer, thereby producing tags composed of customers' copies, invoices, original arrival slips, and the like.

Next, assemblages of the merchandise would be grouped depending on the destinations and put into cases for delivery. Then the cases would be packed up and the tags would be attached thereto. Furthermore, the destinations would be read out of the tags and the packs would be assorted depending on areas of destinations and loaded on trucks for distribution, whereby the merchandise would be delivered to the destinations.

As described above, in the conventional shipment-supporting method for merchandise, various information processing has been performed to produce different slips and the like in the shipping and delivering operations of the ordered merchandise. Accordingly, an operator had to confirm and check the slips and the like with eyes while performing the operations.

For example, the shipping list is firstly produced and printed on paper or the like for the shipping operation. Thereafter, the operator assembles the merchandise, while seeing this shopping list, then merchandise information for assortment is printed on the tag which is attached to a case. Moreover, upon loading the merchandise to be delivered on the truck, the operator would confirm the merchandise to be loaded while seeing a delivery statement (slip), and work on unloading the merchandise at the destination while confirming the delivery statement. For this reason, a burden on the operator has increased and time required for a period from order acceptance to delivery has also increased.

Meanwhile, since the carbon copy paper has been used for the tags as described above, the same print contents have been printed on all of the customers' copies, the invoices, the original arrival slips, and the like. For this reason, the same tags have been attached to the merchandise irrespective of whether the shopkeeper and the shipping place were identical or different, or in the case of the gift purpose. Accordingly, the tags would show unnecessary information to the destinations and thereby would constitute a confusing factor.

Moreover, a business style of holding a virtual shopping mall on the Internet for trading of merchandise is becoming pervasive in recent years.

Accordingly, an effective method for supporting shipment of merchandise between a shopkeeper and a shipping place upon acceptance of an order for merchandise has been anticipated.

### DISCLOSURE OF THE INVENTION

The present invention has been made in consideration of the above. An object of the present invention is to provide a shipment-supporting method for a virtual shopping mall capable of contributing to reduction in operation steps and operation time from acceptance of order information to shipment of merchandise.

The gist of the present invention includes a shipment-supporting method for a virtual shopping mall having an order-accepting server for receiving order information from a purchaser of merchandise presented to a shop in a virtual shopping mall, a shopkeeper terminal who presents the merchandise, a shipping-place terminal where the merchandise is shipped from, and a shipment-supporting server for performing information communication between the shopkeeper terminal and the shopping-place terminal through a communication line, and for supporting shipment of the merchandise for which the order-accepting server accepted an order. Here, the shipment-supporting server generates a shipping instruction pending list, which shows the state where shipment of the merchandise is not instructed yet, based on the received order information and transmits the shipping instruction pending list to the shopkeeper terminal. Then, the shopkeeper terminal generates transport information and shipping place information for shipping the merchandise, and a shipping instruction request based on the received shipping instruction pending list and transmits the transport information, the shipping place information, and the shipping instruction request to the shipment-supporting server. Then, the shipment-supporting server generates a shipment pending list, which represents the unshipped merchandise depending on each shipping place, based on the received transport information, the shipping place information, and the shipping instruction request, and then transmits the shipment pending list to each shipping-place terminal. Then, the shipping-place terminal displays the received shipment pending list and transmits a request for shipping instruction information concerning this unshipped merchandise to the shipment-supporting server. Then, the shipment-supporting server generates a shipping instruction list and tag data in response to the received request for shipping instruction information and transmits the shipping instruction list and the tag data to the shipping-place terminal. Then the shipping-place terminal prints out the received shipping instruction list and the tag data.

Moreover, the gist includes an aspect that the shipment-supporting server urges the shopkeeper terminal to input a change in a shipment unit of the merchandise, and transmits the shipment unit of the merchandise received from the shopkeeper terminal to the shipping-place terminal.

Moreover, the gist includes an aspect that the shipment-supporting server urges the shopkeeper terminal to input a change in the transport information and/or the shipping place information of the merchandise, and transmits the transport information and/or the shipping place information of the merchandise, which is received from the shopkeeper terminal to the shipping-place terminal.

Moreover, the gist includes an aspect that the shipment-supporting server urges the shipping-place terminal to input a quantity of packages of the merchandise, and generates the tag data based on the quantity of packages of the merchandise received from the shipping-place terminal.

Moreover, the gist includes an aspect that the shopkeeper terminal is integrated with the order-accepting server.

Moreover, the gist includes an aspect that the shipping-place terminal is integrated with the shopkeeper terminal.

Moreover, the gist includes an aspect that the shopkeeper terminal and the shipping-place terminal are integrated with the order-accepting server.

### BRIEF DESCRIPTION OF THE DRAWINGS

FIG. 1 is a view showing a system configuration of a shipment-supporting system according to a first embodiment of the present invention.

FIG. 2 is a block diagram showing a configuration of an order-accepting server in the shipment-supporting system according to the first embodiment of the present invention.

FIG. 3 is a block diagram showing a configuration of a shipment-supporting server in the shipment-supporting system according to the first embodiment of the present invention.

FIG. 4 is a block diagram showing a configuration of a shipping-place terminal in the shipment-supporting system according to the first embodiment of the present invention.

FIG. 5 is a block diagram showing a configuration of a shopkeeper terminal in the shipment-supporting system according to the first embodiment of the present invention.

FIG. 6A is a flowchart for explaining an operation in an order-accepting system by the shipment-supporting server, and FIG. 6B is a view showing a file configuration of order information.

FIG. 7A is a flowchart for explaining an operation in a shipping instruction system by the shipment-supporting server, and FIG. 7B is a view showing a file configuration of a shipping instruction list.

FIG. 8A is a flowchart for explaining an operation in a shipping operation system by the shipment-supporting server, and FIG. 8B is a view showing a file configuration of a shipment pending list.

FIG. 9 is a sequence chart showing communication exchanges performed by the shipment-supporting system according to the first embodiment of the present invention.

FIG. 10 is a view showing a display screen example to be displayed on a purchaser terminal.

FIG. 11 is a view showing another display screen example to be displayed on the purchaser terminal.

FIG. 12 is a view showing a display screen example indicating a menu screen of a homepage to be displayed on the shopkeeper terminal.

FIG. 13 is a view showing a display screen example of a shipping instruction pending list to be displayed on the shopkeeper terminal.

FIG. 14 is a view showing a display screen example for correction of address of a destination to be displayed on the shopkeeper terminal.

FIG. 15 is a view showing a display screen example for updating a shipment unit to the shipping instruction pending list to be displayed on the shopkeeper terminal.

FIGS. 16A to 16C are views showing display screen examples to be displayed on the shopkeeper terminal, of which FIG. 16A represents a state before updating the shipment unit concerning the shipping instruction pending list, FIG. 16B represents a state after updating the shipment unit, and FIG. 16C represents the shipping instruction pending list after updating the shipment unit.

FIGS. 17A to 17C are views showing display screen examples to be displayed on the shopkeeper terminal, of which FIG. 17A shows details of a shipping instruction, FIG. 17B shows transport information, and FIG. 17C shows shipping place information.

FIG. 18 is a view showing a display screen example of a shipping place menu to be displayed on the shipping-place terminal.

FIG. 19 is a view showing a display screen example of the shipment pending list to be displayed on the shipping-place terminal.

FIG. 20 is a view showing a printing example of the shipping instruction list to be printed out of a printer for the shipping-place terminal.

FIG. 21 is a view showing a display screen example of a tag output to be displayed on the shipping-place terminal.

FIG. 22 is a view showing a display screen example representing that a quantity of packages is inputted to the tag output to be displayed on the shipping-place terminal.

FIG. 23 is a view showing the entire constitution of a tag to be printed out of the printer of the shipping-place terminal.

FIG. 24 is a view showing a configuration of a customer's copy which is part of a tag (ordinary, shopkeeper ? shipping place).

FIG. 25 is a view showing a configuration of an invoice-cum-tag which is part of the tag (ordinary, shopkeeper ? shipping place).

FIG. 26 is a view showing a configuration of an original arrival slip which is part of the tag (ordinary, shopkeeper ? shipping place).

FIG. 27 is a view showing a configuration of a customer's copy which is part of a tag (gift, shopkeeper ? shipping place).

FIG. 28 is a view showing a configuration of an invoice-cum-tag which is part of the tag (gift, shopkeeper ? shipping place).

FIG. 29 is a view showing a configuration of an original arrival slip which is part of the tag (gift, shopkeeper ? shipping place).

FIG. 30 is a view showing a system configuration of a shipment-supporting system according to a second embodiment of the present invention.

FIG. 31 is a sequence chart showing communication exchanges performed by the shipment-supporting system according to the second embodiment of the present invention.

FIG. 32 is a view showing a system configuration of a shipment-supporting system according to a third embodiment of the present invention.

FIG. 33 is a sequence chart showing communication exchanges performed by the shipment-supporting system according to the third embodiment of the present invention.

FIG. 34 is a view showing a configuration of a customer's copy which is part of a tag (ordinary, shopkeeper=shipping place).

FIG. 35 is a view showing a configuration of an original arrival slip which is part of the tag (ordinary, shopkeeper=shipping place).

FIG. 36 is a view showing a configuration of a customer's copy which is part of a tag (gift, shopkeeper=shipping place).

FIG. 37 is a view showing a configuration of an original arrival slip which is part of the tag (gift, shopkeeper=shipping place).

FIG. 38 is a view showing a system configuration of a shipment-supporting system according to a fourth embodiment of the present invention.

FIG. 39 is a sequence chart showing communication exchanges performed by the shipment-supporting system according to the fourth embodiment of the present invention.

### BEST MODES FOR CARRYING OUT THE INVENTION

In order to explain the present invention further in detail, description thereof will be made in accordance with the accompanying drawings.

(First Embodiment)

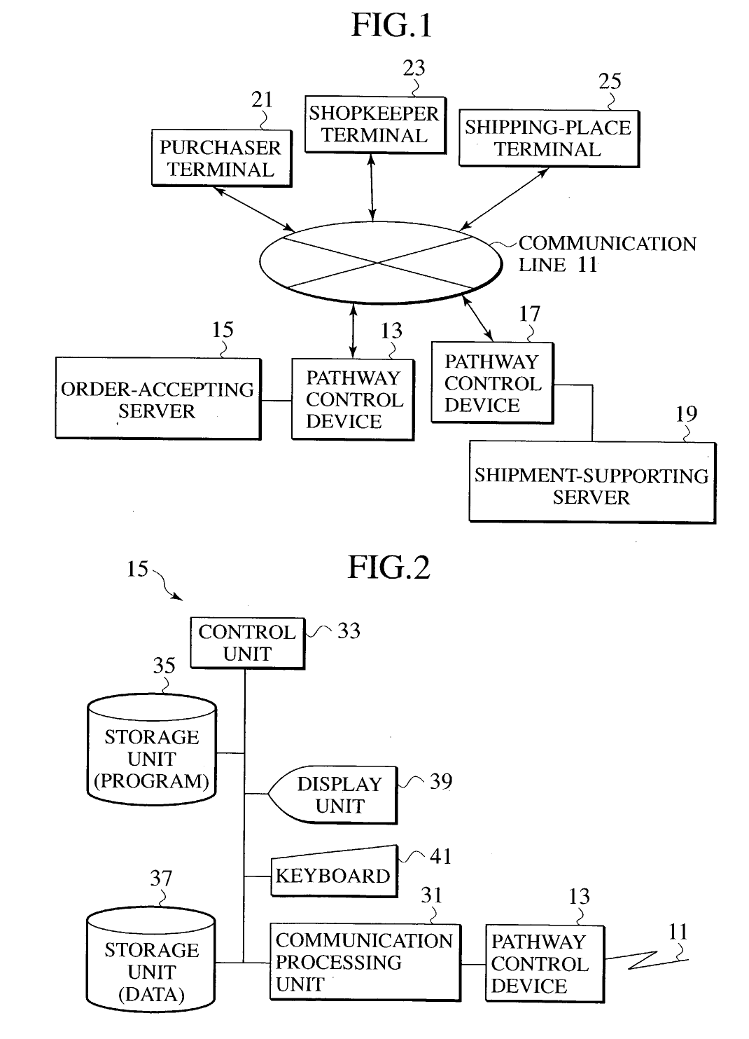

FIG. 1 shows a system configuration of a shipment-supporting system according to a first embodiment of the present invention.

As shown in FIG. 1, to a communication line 11 composed of telephone lines and the Internet, connected are: pathway control devices 13 and 17 which exchange pathway information with the communication line 11 so as to select the most appropriate pathway automatically; an order-accepting server 15 which is connected through the pathway control device 13 and accepts order information from a purchaser of merchandise presented to a shop in a shopping mall on the Internet, for example; a shipment-supporting server 19 which is installed at a home delivery contractor connected through the pathway control device 17; a purchaser terminal 21 installed at a home of the purchaser; a shopkeeper terminal 23 installed at a home of a shopkeeper individual or at a shopkeeper company who presents the merchandise; and a shipping-place terminal 25 installed at a shipping place for shipping the merchandise.

Next, as shown in FIG. 2, the order-accepting server 15 is composed of a communication processing unit 31, a control unit 33, a storage unit 35, a storage unit 37, a display unit 39, and a keyboard 41.

The communication processing unit 31 interposes the pathway control device 13 and thereby performs information communication with a plurality of purchaser terminals 21 through the communication line 11.

The control unit 33 includes a timer for clocking date and hour inside thereof, and controls the respective units provided in the server. The storage unit 35 stores an OS program for controlling the server, a browser program, and control data. The storage unit 37 stores the order information as a database. The display unit 39 displays contents of input and a control state. The keyboard 41 inputs character information.

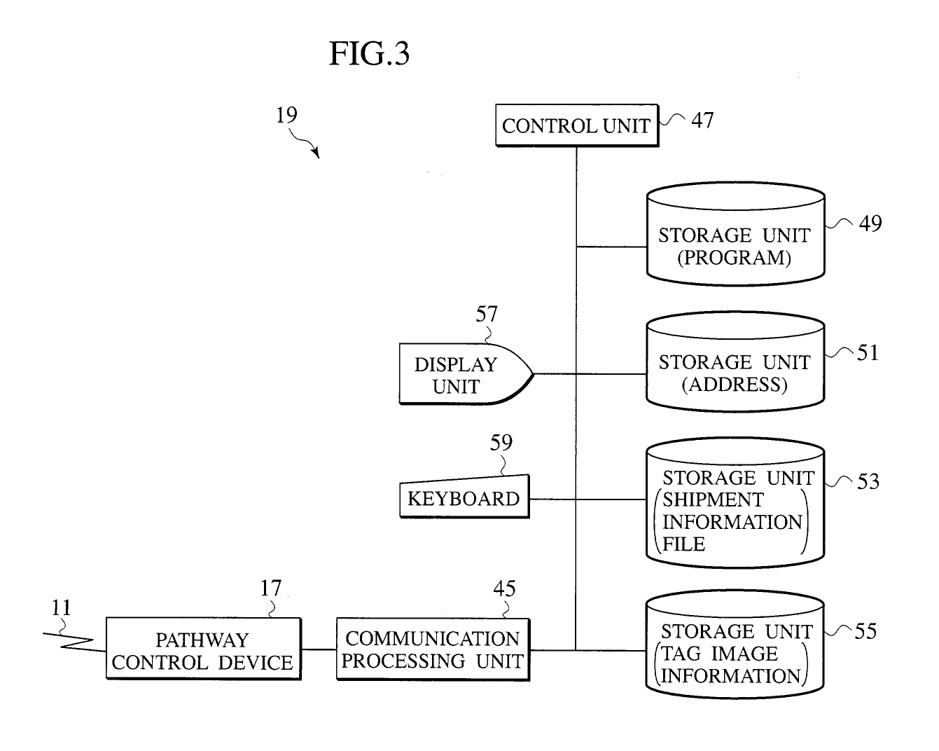

Next, as shown in FIG. 3, the shipment-supporting server 19 is composed of a communication processing unit 45, a control unit 47, a storage unit 49, a storage unit 51, a storage unit 53, a display unit 57, and a keyboard 59.

The communication processing unit 45 interposes the pathway control device 13 and thereby performs information communication with a plurality of order-accepting servers 15 and shipping-place terminals 25 through the communication line 11. The control unit 47 includes a timer for clocking date and hour inside thereof, and controls the respective units provided in the server. The storage unit 49 stores an OS program for controlling the server, a browser program, and control data. The storage unit 51 stores address information as a database. The storage unit 53 stores shipment information as a database depending on order numbers. The storage unit 55 stores tag image information as a database. The display unit 57 displays contents of input, a control state, and the like. The keyboard 59 inputs character information to the control unit 47.

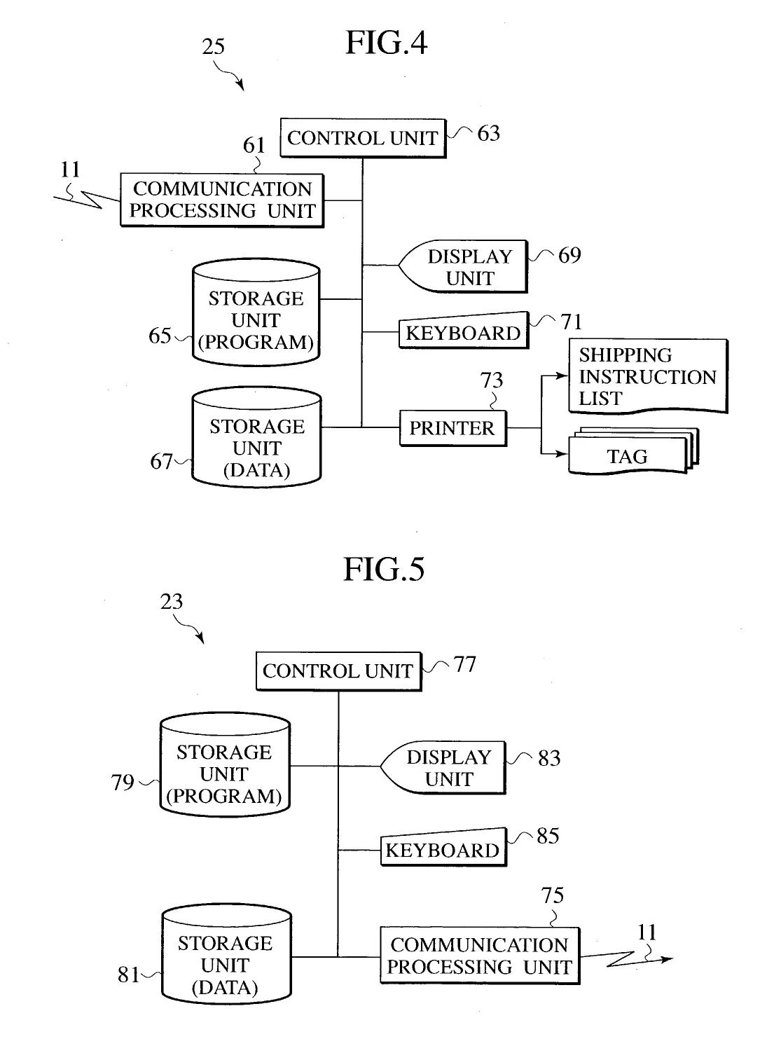

Next, as shown in FIG. 4, the shipping-place terminal 25 is composed of a communication processing unit 61, a control unit 63, a storage unit 65, a storage unit 67, a display unit 69, a keyboard 71, and a printer 73.

The communication processing unit 61 performs information communication with the shipment-supporting server 19 through the communication line 11. The control unit 63 includes a timer for clocking date and hour inside thereof, and controls the respective units provided in the terminal. The storage unit 65 stores an OS program for controlling the terminal, a browser program, and control data. The storage unit 67 stores data received from the shipment-supporting server 19. The display unit 69 displays contents of input, a control state, and the like. The keyboard 71 inputs character information to the control unit 63. The printer prints a shipping instruction list and a tag.

Next, as shown in FIG. 5, the shopkeeper terminal 23 is composed of a communication processing unit 75, a control unit 77, a storage unit 79, a storage unit 81, a display unit 83, and a keyboard 85.

The communication processing unit 75 performs information communication with the shipment-supporting server 19 through the communication line 11. The control unit 77 includes a timer for clocking date and hour inside thereof, and controls the respective units provided in the terminal. The storage unit 79 stores an OS program for controlling the terminal, a browser program, and control data. The storage unit 81 stores data received from the shipment-supporting server 19. The display unit 83 displays contents of input, a control state, and the like. The keyboard 85 inputs character information to the control unit 77.

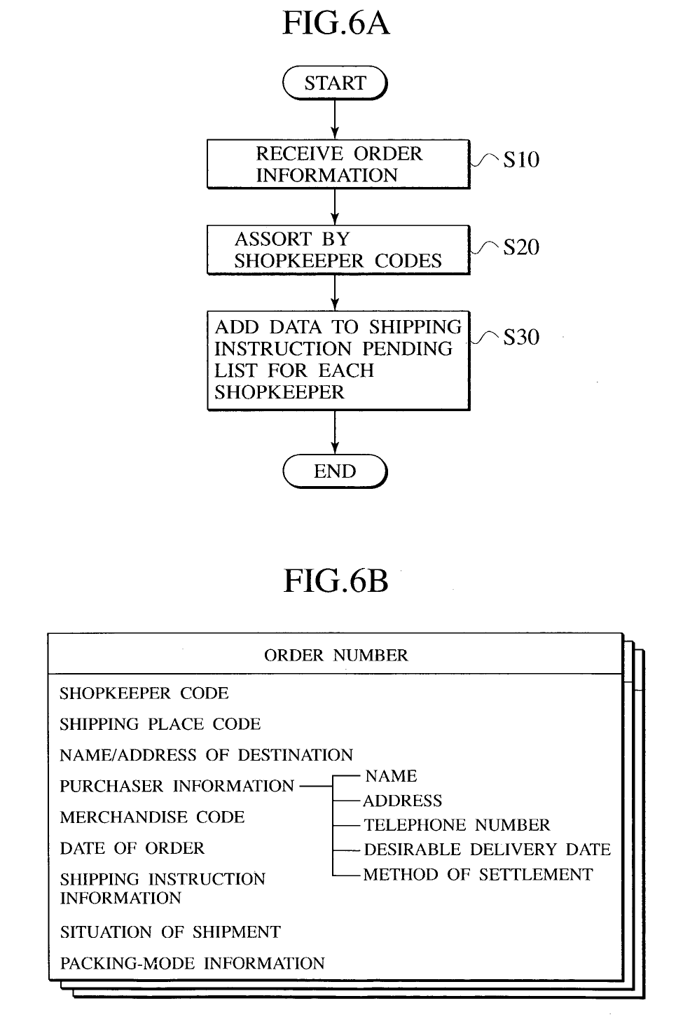

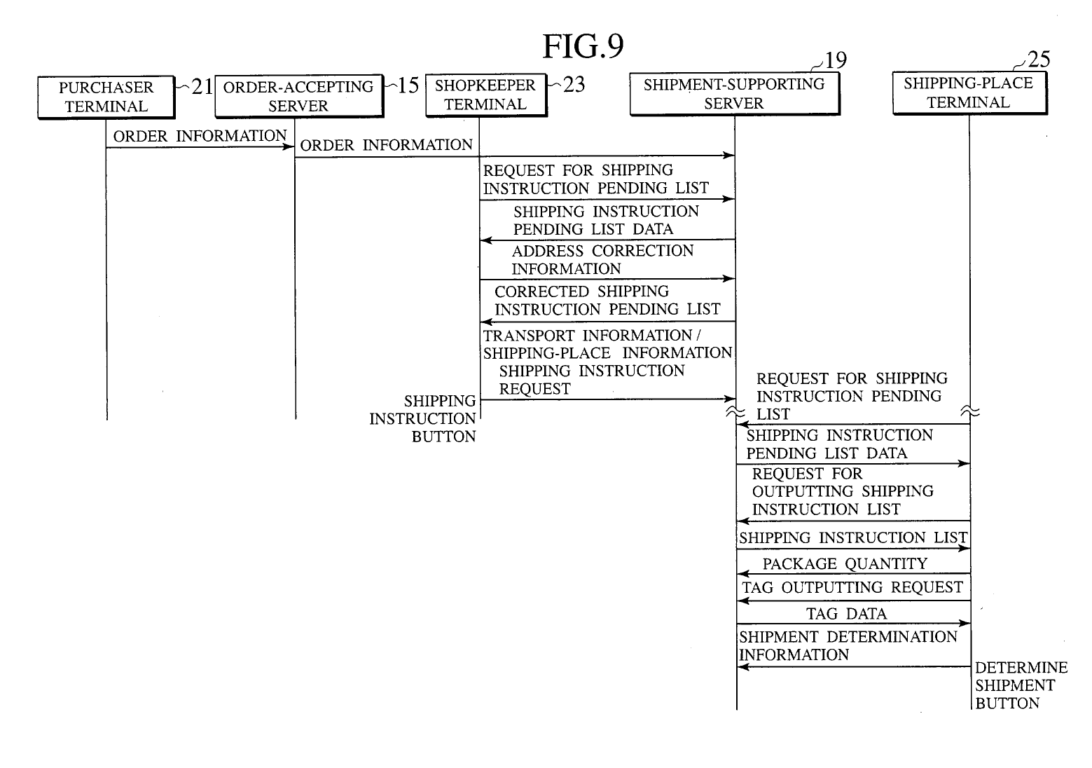

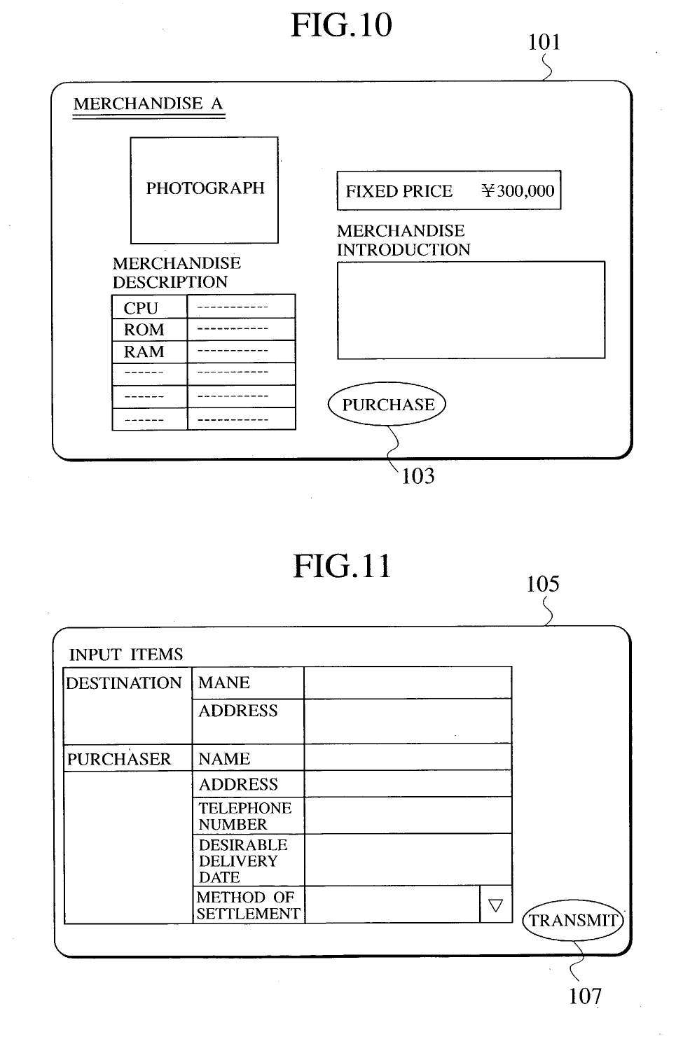

Next, description will be made regarding operations of the shipment-supporting system according to the first embodiment of the present invention with reference to flowcharts shown in FIG. 6 to FIG. 8, a sequence chart shown in FIG. 9, and display examples shown in FIG. 10 to FIG. 26.

When the shopkeeper registers merchandise with a shopping mall opened on the Internet, firstly merchandise information which contains text information and image information for illustrating contents of the merchandise to be an object for sale is generated with the shopkeeper terminal 23, and the merchandise information is transmitted to the order-accepting server 15 through the communication line 11.

The order-accepting server 15, which receives pieces of the merchandise information on the merchandise to be objects for sale from a plurality of shopkeeper terminals 23, assigns shopkeeper codes to the respective shopkeepers and further assigns merchandise codes to the respective pieces of the merchandise information. Then, the order-accepting server 15 stores these shopkeeper codes and merchandise codes in the storage unit 37 and returns the shopkeeper codes and the merchandise codes thus assigned to the respective shopkeeper terminals 23.

Thereafter, the order-accepting server 15 generates the respective pieces of merchandise information accepted from the plurality of shopkeeper terminals 23 in a homepage for presenting in the Internet shopping mall, and stores this homepage in the storage unit 37.

Here, a purchaser operates the purchaser terminal 21 made of a personal computer, and launches the browser program, then specifies a given URL address and accesses the order-accepting server 15 through the communication line 11. In this event, the order-accepting server 15 reads the homepage specified by the URL address out of the storage 37 and transmits the homepage to the purchaser terminal 21.

Upon receipt of the homepage for the Internet shopping mall from the order-accepting server 15, the purchaser terminal 21 displays image information 101 regarding this homepage on the display unit as shown in FIG. 10.

Then, the purchaser browses the homepage displayed on the display unit of the purchaser terminal 21 and selects the merchandise that the purchaser wishes to purchase out of two or more pieces of the merchandise. When a “purchase” button 103 is clicked by the purchaser, then the next display screen (not shown) develops. Terms-of-service text for the shopping mall is displayed on this display screen. As the purchaser reads sequentially therethrough, “agreed” and “disagreed” buttons are displayed. If the “agreed” button is clicked in this event, then the next display screen 105 develops as shown in FIG. 11.

In FIG. 11, a name and an address of a destination, a name, an address and a telephone number of the purchaser, a desirable delivery date, a method of settlement, and the like are displayed on the display unit of the purchaser terminal 21 as input items, and input thereto is thereby promoted. If these respective items are inputted by operating the keyboard and a mouse and a “transmit” button 1017 is clicked, then the purchaser terminal 21 generates order information containing the merchandise code representing merchandise A and the above-mentioned input items, and transmits the order information to the order-accepting server 15.

As shown in the sequence chart illustrated in FIG. 9, the order-accepting server 15 which accepts such order information from the plurality of purchaser terminals 21, for example, attaches the shopkeeper codes and individual order numbers to such order information, and transmits the information to the shipment-supporting server 19 through the communication line 11.

Here, an operation of the shipment-supporting server 19 will be described with reference to an ordering system flowchart shown in FIG. 6.

Moving to FIG. 6, in Step S10, the shipment-supporting server 19 receives the order information concerning a plurality of merchandise, for example, from the order-accepting server 15 through the communication line 11.

Here, as shown in FIG. 6B, the above-described order information includes a cluster of files for each order number. To be more precise, the order information is composed of the shopkeeper code assigned to each shopkeeper, a shipping place code assigned to each shipping place, the name/address of the destination, information on the purchaser of the merchandise including the name, the address, the telephone number, the desirable delivery date, the method of settlement and the like, the merchandise code assigned to each piece of merchandise, a date of order, shipping instruction information, a situation of shipment, packing-mode information, and the like.

Thereafter, in Step S20, the shipment-supporting server 19 assorts the order information by the shopkeeper codes, based on the shopkeeper codes attached to the received order information. Then, in Step S30, data are referenced out of the order information depending on each shopkeeper code (shopkeeper) and stores the data additionally to a shipping instruction pending list which is stored in the storage unit 53.

Here, description will be made regarding contents of operations with the shopkeeper terminal 23.

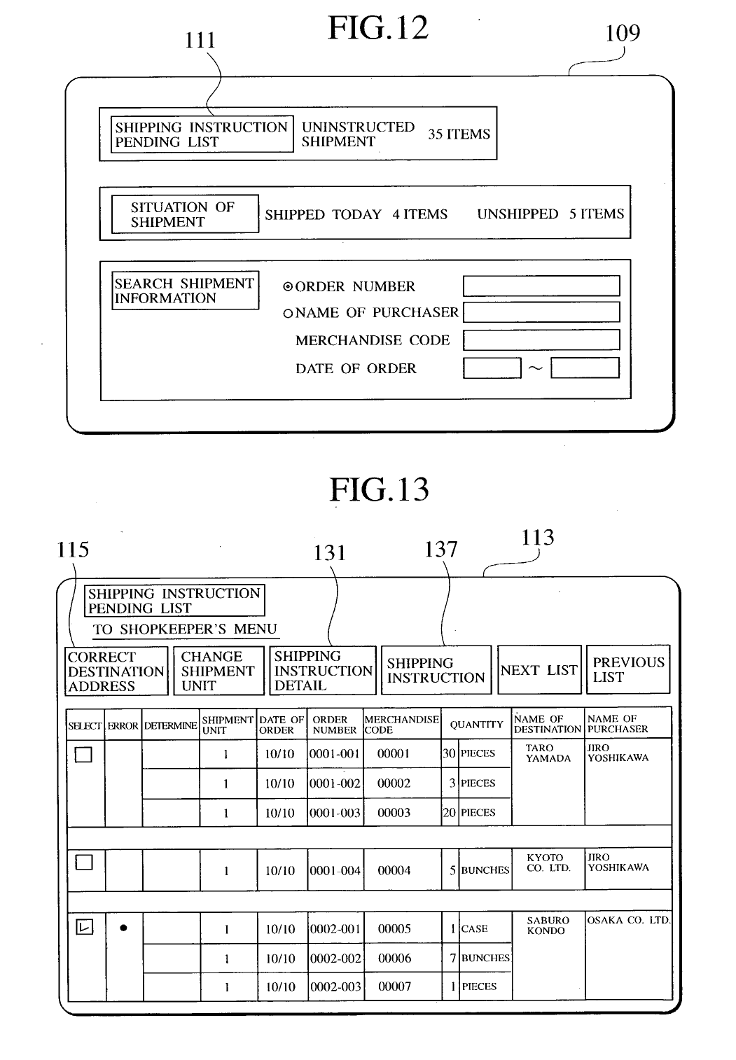

Firstly, the shopkeeper operates the shopkeeper terminal 23 made of a personal computer and runs the browser program. Then, the shopkeeper specifies a URL address of the shipment-supporting server 19 on the display screen and accesses the shipment-supporting server 19 through the communication line 11. In this event, the shipment-supporting server 19 reads the homepage specified by the URL address out of the storage unit 53 and transmits the homepage to the shopkeeper terminal 23. Upon receipt of the homepage concerning a shipping instruction, the shopkeeper terminal 23 displays a display screen 109, which represents a menu screen of this homepage, on the display unit as shown in FIG. 12.

Then, the shopkeeper browses the homepage displayed on the display unit of the shopkeeper terminal 23. Since there are “35 items” of orders, for example, which are not instructed for shipping yet as shown in FIG. 12, the shopkeeper clicks a “shipping instruction pending list” button 111 to confirm detailed contents. In this case, a request for the shipping instruction pending list is transmitted to the shipment-supporting server 19 through the communication line 11.

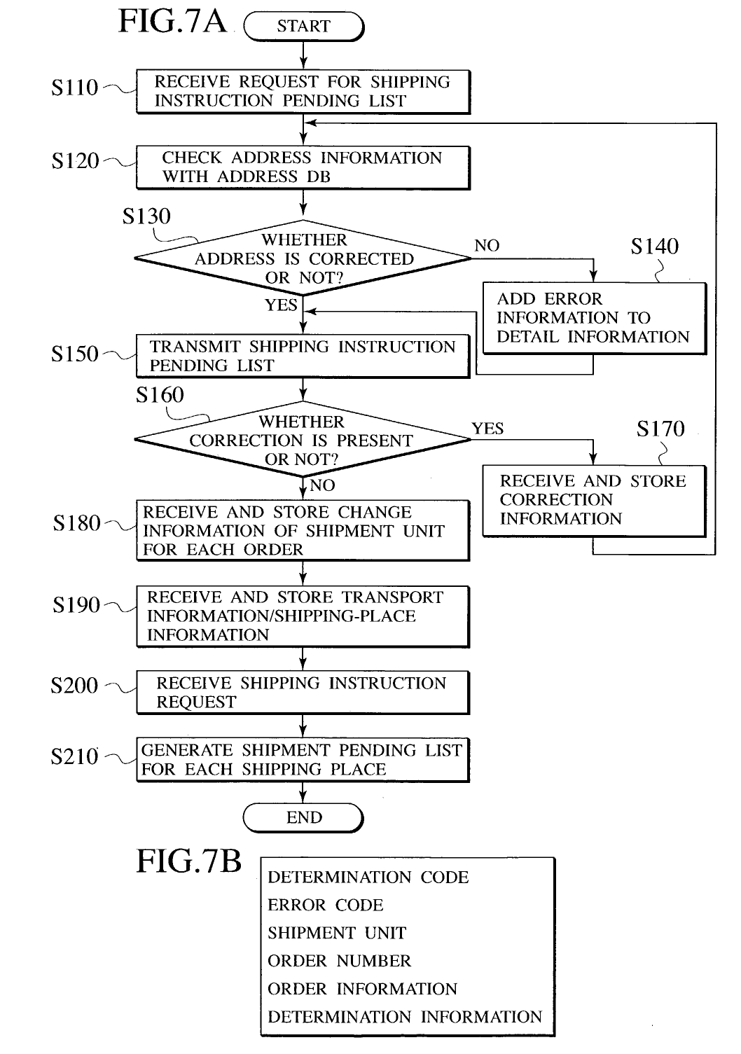

Here, an operation of the shipment-supporting server 19 will be described with reference to a shipping instruction system flowchart shown in FIG. 7.

Moving to FIG. 7, in Step S110, the shipment-supporting server 19 receives the request for the shipping instruction pending list from the shopkeeper terminal 23 through the communication line 11. Then, in Step S120, a matching check is performed on the address information in the shipping instruction pending list stored in the storage unit 53 based on the address information stored in the storage unit 51. In Step S130, judgment is made as to whether the address information stored in the shipping instruction pending list is correct or not.

Here, if the address information stored in the shipping instruction pending list is not correct, then the process goes to Step S140 and error information is attached to the shipping instruction pending list. Thereafter, in Step S150, the shipping instruction pending list composed of the data as shown in FIG. 7A is transmitted to the shopkeeper terminal 23 through the communication line 11.

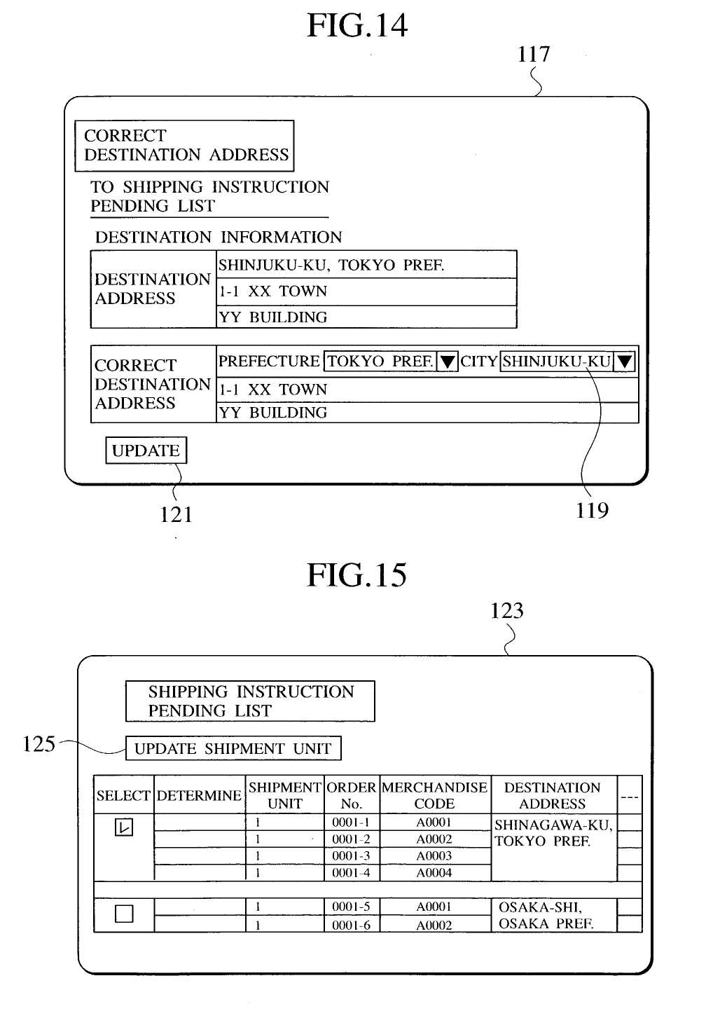

As a result, at the shopkeeper terminal 23, the display screen displayed on the display unit moves to the next display screen 113 shown in FIG. 13. Since the shopkeeper discovers the error information “●” out of the shipping instruction pending list displayed on the display unit, the shopkeeper clicks and thereby checks a select field by use of the mouse. Next, when a “correct destination address” button 115 is clicked, then this “correct destination address” image information 117 is displayed on the display unit as shown in FIG. 14.

Here, for example “Sinjuku-ku, Tokyo” is erroneously displayed as the destination address on the display unit. Since this display position indicates an error, the shopkeeper clicks a pull-down menu 119 for “address” by use of the mouse, and finds out the regular address “Shinjuku-ku”, and subsequently clicks an “update” button 121. When the “update” button 121 is clicked, a request for correcting the destination address is transmitted from the shopkeeper terminal 23 to the shipment-supporting server 19 together with a request for correcting the destination address through the communication line 11.

In the meantime, in Step S160, the shipment-supporting server 19 judges as to whether or not correction of the error is necessary depending on whether the request for correcting the destination address is received or not. Here, if the correction of the error is necessary, then the process goes to Step S170, receives the correction information stating “Shinjuku-ku”, and then correct and stores the relevant item in the shipping instruction pending list stored in the storage unit 53. Thereafter, the process returns to Step S120, and the processing is repeated.

As described above, even if the order information received from the purchaser terminal 21 through the order-accepting server 15 contains an error in the address information, it is possible to transmit the shipping instruction pending list, which is corrected to the regular address information, to the shopkeeper terminal 23.

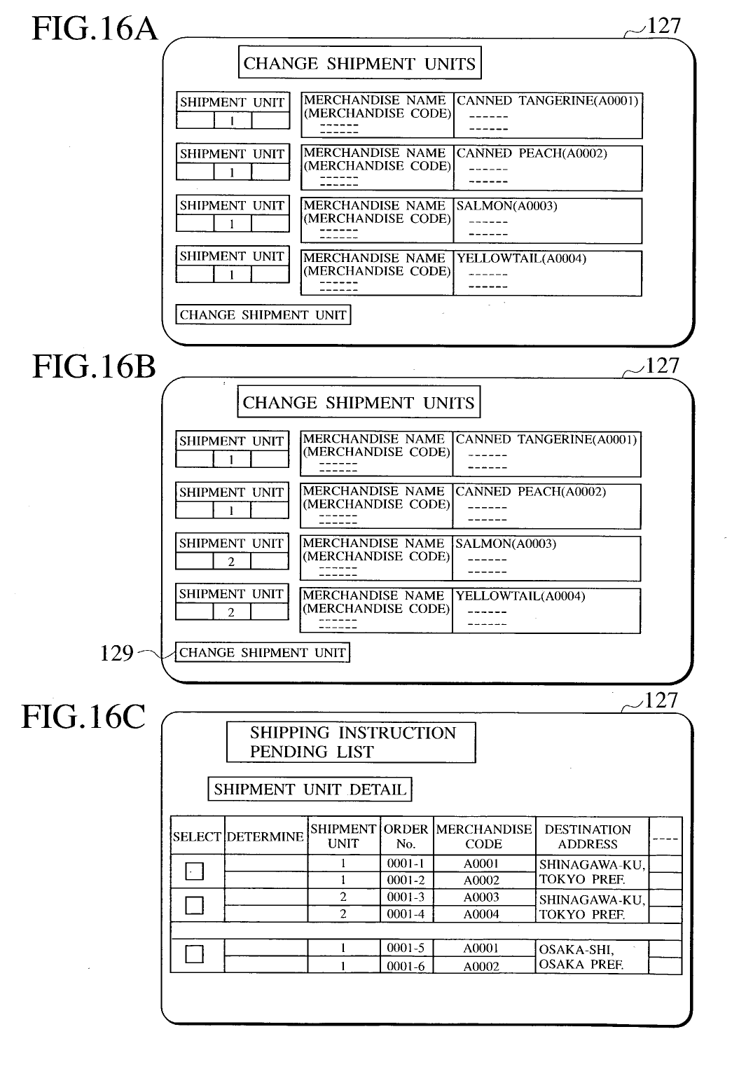

Next, a display screen 123 shown in FIG. 15 is displayed on the display unit of the shopkeeper terminal 23. Here, in order to change a shipment unit for each order, the shopkeeper clicks and thereby checks a desired select field out of the shipping instruction pending list displayed on the display unit by use of the mouse. Next, when a “change shipment unit” button 125 is clicked, a display screen 127 is displayed on the display unit as shown in FIG. 16A.

As shown in FIG. 16A, if the name of the merchandise is a “canned tangerine” (A001) or a “canned peach” (A002), then the merchandise can be sent by an ordinary delivery. However, since “salmon” (A003) or “yellowtail” (A004) is a perishable food, the merchandise needs to be sent by a refrigerated delivery in this case. For this reason, the units of packages are changed as shown in FIG. 16B, and then a “change shipment unit” button 129 is clicked. As a result, as shown in FIG. 16C, the shipment units corresponding to the merchandise codes (A003) and (A004) are changed to “2”.

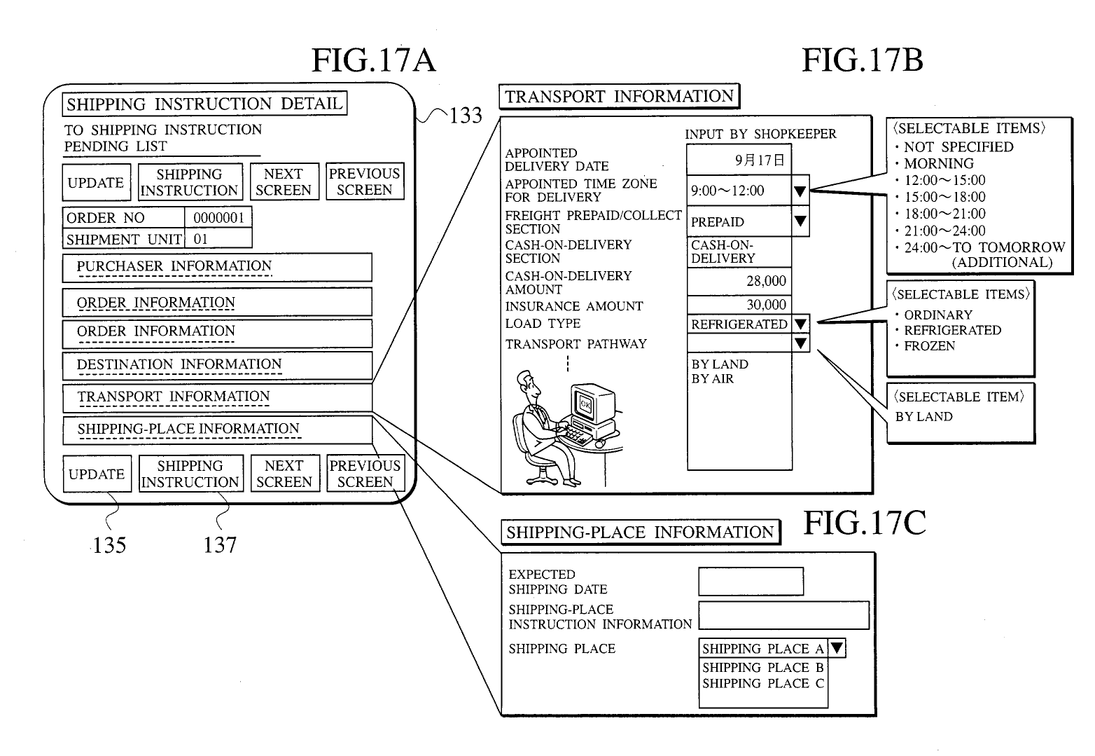

Moving to FIG. 13, by clicking a “shipping instruction detail” button 131 which is displayed on the display unit for specifying transport information and shipping-place information, a display screen 133 for the “shipping instruction detail” is displayed as shown in FIG. 17A.

As described above, since the shipment unit is changeable for each piece of the merchandise from the shopkeeper terminal 23, it is possible to specify a refrigerated delivery or an ordinary delivery for each piece of the merchandise, and to transport the merchandise to the destination accordingly.

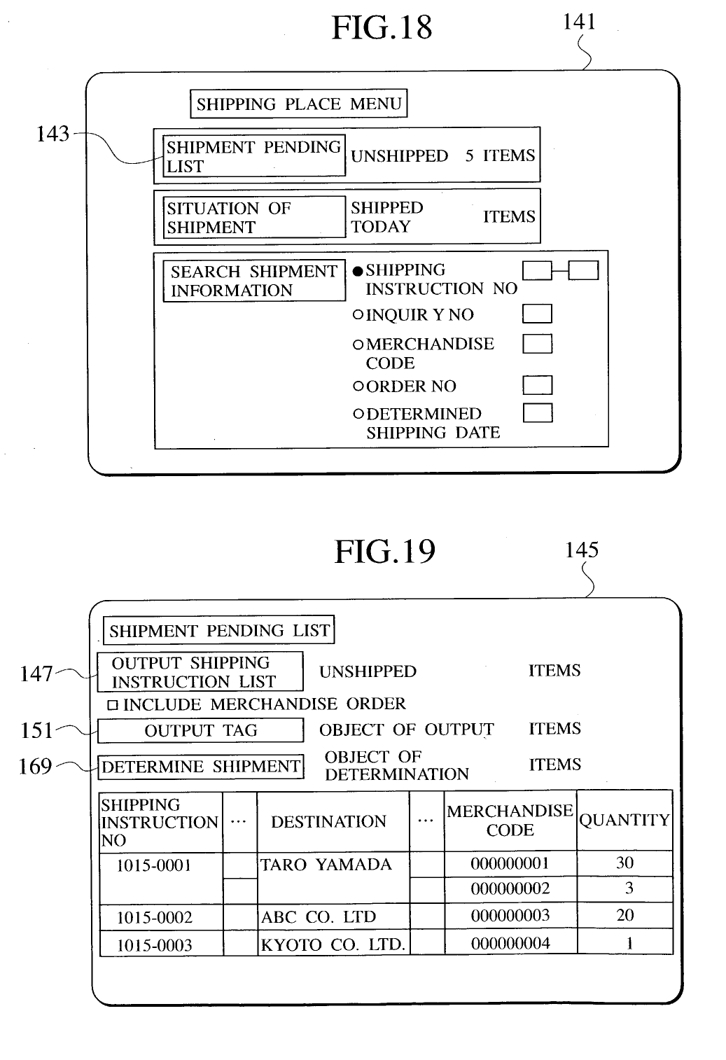

Here, if a display area for the “shipping-place information” within the display screen 133 for the “shipping instruction detail” shown in FIG. 17A is clicked, then detailed contents of the transport information is displayed as shown in FIG. 18. Moreover, when an arrow mark “▾” is clicked, then a pull-down menu of the relevant item is displayed.

Moreover, if a display area for the “shipping-place information” within the display screen 133 for the “shipping instruction detail” shown in FIG. 17A is clicked, then detailed contents of the shipping-place information is displayed as shown in FIG. 17B. Moreover, when an arrow mark “▾” is clicked, then a pull-down menu of the relevant item is displayed.

Thereafter, the shopkeeper sets desired items concerning the transport information or the shipping-place information by use of the keyboard 85 or the mouse provided in the shopkeeper terminal 23, and finally presses an “update” button 135 shown in FIG. 17A. Then, the transport information or the shipping-place information is updated to the current setting items.

To be more precise, concerning the transport information, detail items including an appointed date for delivery, delivery time, a freight prepaid/collect section, a cash-on-delivery section, a cash-on-delivery amount, an insurance amount, a load type, a transport pathway, and the like can be inputted for change. Meanwhile, concerning the shipping-place information, detail items including an expected date for delivery, shipping-place instruction information, the shipping place, and the like can be inputted for change. As a result, it is possible to specify the transport information or the shipping-place information which meets the requests from the shopkeeper.

Then, if a “shipping instruction” button 137 shown in FIG. 13 or FIG. 17A is clicked, the shopkeeper terminal 23 transmits a shipping instruction request to the shipment-supporting server 19 together with the above-described transport information and shipping-place information.

Moving to FIG. 7, in Step S180, the shipment-supporting server 19 receives change information of the shipment unit for each order from the shopkeeper terminal 23 through the communication line 11 and stores the change information in the storage unit 53. Then, in Step S190, the shipment-supporting server 19 receives the transport information and the shipping-place information from the shopkeeper terminal 23 and stores the transport information and the shipping-place information in the storage unit 53. Furthermore, in Step S200, the shipment-supporting server 19 receives the shipping instruction request from the shopkeeper terminal 23.

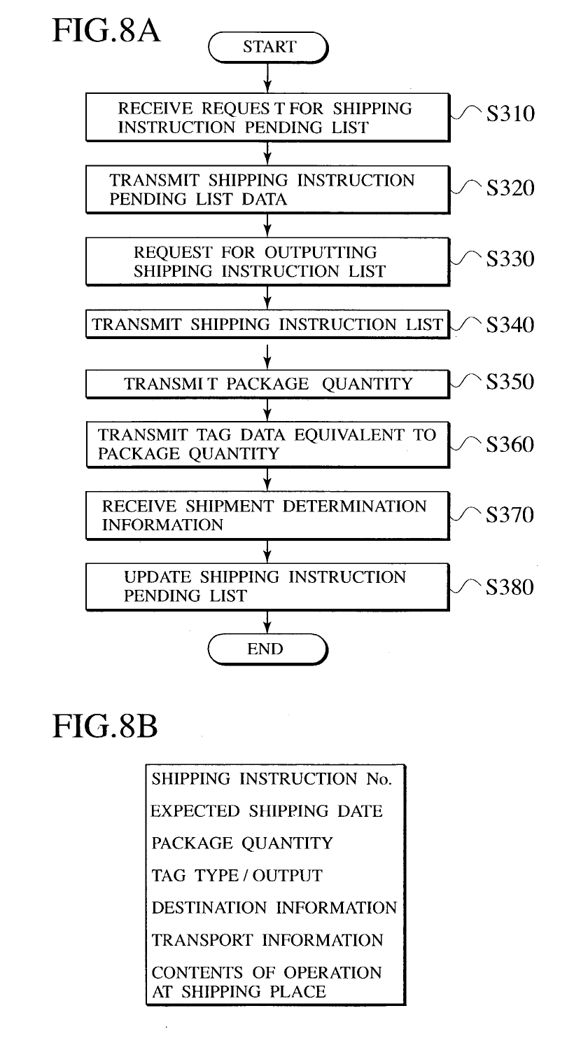

Then, in Step S210, the shipment-supporting server 19, which received the shipping instruction request from the shopkeeper terminal 23 together with the transport information and the shipping-place information, generates a shipment pending list to be described later for each shipping place as shown in FIG. 8B based on the received transport information and the shipping-place information, and stores the shipment pending list in the storage unit 53.

As described above, since the detail points on the transport information and the shipping-place information can be inputted for change from the shopkeeper terminal, it is possible to specify the transport information and the shipping-place information so as to meet the requests from the shopkeeper.

Next, description will be made regarding contents of an operation with the shipping-place terminal 25.

Firstly, a shipper operates the shipping-place terminal 25 made of a personal computer and runs the browser program, then specifies a URL address of the shipment-supporting server 19 and thereby accesses the shipment-supporting server 19 through the communication line 11. In this event, the shipment-supporting server 19 reads the homepage specified by the URL address out of the storage 53 and transmits the homepage to the shipping-place terminal 25. Upon receipt of the homepage concerning a shipping operation from the shipment-supporting server 19, the shipping-place terminal 25 displays image information 141 regarding this homepage on the display unit as shown in FIG. 18.

Then, the shipper browses the homepage displayed on the display unit of the shipping-place terminal 25. As shown in FIG. 18, since there are “5 items” of unshipped items, for example, the shipper clicks a “shipment pending list” button 143 to confirm detailed contents. In this case, a request for the shipment pending list with attachment of the shipping place code is transmitted from the shipping-place terminal 25 to the shipment-supporting server 19 through the communication line 11.

Here, an operation of the shipment-supporting server 19 will be described with reference to a shipping operation system flowchart shown in FIG. 8.

In Step S310, the shipment-supporting server 19 received the request for the shipment pending list with attachment of the shipping place code from the shipping-place terminal 25 through the communication line 11. Then, in Step S320, the shipment-supporting server 19 reads data corresponding to the relevant shipping place code out of the shipment pending list data stored in the storage unit 53, and transmits the shipment pending list data to this shipping-place terminal 25.

Upon receipt of the shipment pending list data from the shipment-supporting server 19, the shipping-place terminal 25 displays a display screen 145 regarding the shipment pending list on the display unit as shown in FIG. 19. Then, the shipper browses the shipment pending list displayed on the display unit of the shipping-place terminal 25, and clicks an “output shipping instruction list” button 147 to instruct shipment of the merchandise. In this case, a request for outputting a shipping instruction list with attachment of the shipping place code is transmitted from the shipping-place terminal 25 to the shipment-supporting server 19 through the communication line 11.

In Step S330, the shipment-supporting server 19 receives the request for the shipping instruction list with attachment of the shipping place code from the shipping-place terminal 25 through the communication line 11. Then, in Step S340, the shipment-supporting server 19 generates data for the shipping instruction list corresponding to the relevant shipping place code out of the shipment pending list data stored in the storage unit 53, and transmits the data to the shipping-place terminal 25.

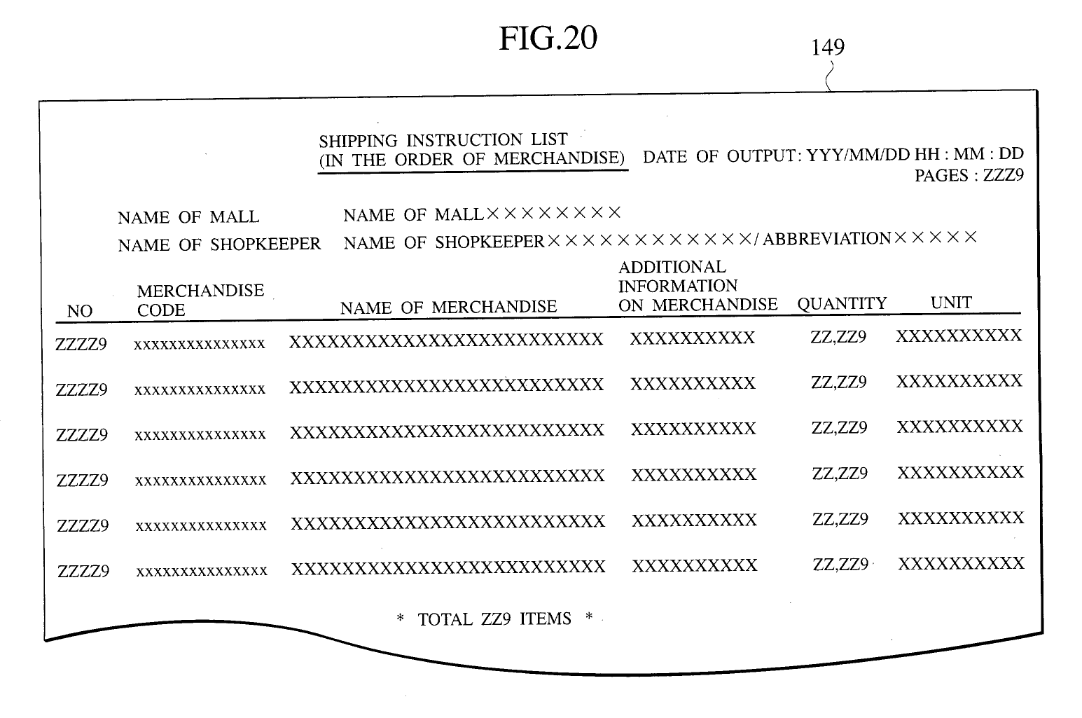

Upon receipt of the data for the shipping instruction list from the shipment-supporting server 19, the shipping-place terminal 25 prints the received data for the shipping instruction list out to the printer 73. As a result, as shown in FIG. 20, a shipping instruction list 149 concerning the relevant shipping place is printed out of the printer 73.

As described above, since the shipping instruction list is printed at the shipping-place terminal based on the data for the shipping instruction list received from the shipment-supporting server, it is possible to curtail a conventional operation of producing a shipping instruction list at a shipping place. Moreover, the order number, the merchandise code, the name of the merchandise, additional information on the merchandise, the quantity, and the unit thereof are described in this shipping instruction list 149 in addition to the name of the Internet shopping mall and the name of the shopkeeper. Accordingly, the shipper can make reference to this shipping instruction list and thereby he can perform picking of the merchandise to be shipped.

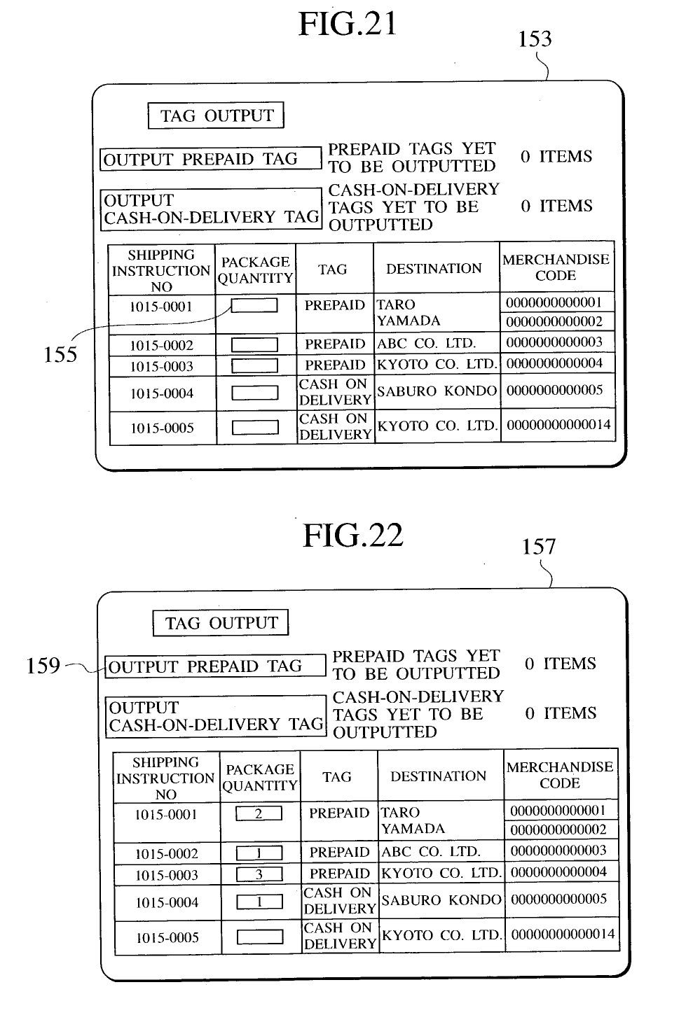

Moving to FIG. 19, the shipper browses the shipment pending list displayed on the display unit of the shipping-place terminal 25. To attach the tag to the merchandise, the shipper clicks an “output tag” button 151. As a result, a display screen 153 concerning tag output is displayed on the display unit of the shipping-place terminal 25 as shown in FIG. 21.

Here, in the case of inputting actual quantities of load packages to “package quantity” items displayed on the display screen 153 of the display unit, a cursor is moved to an input area 155 and the input area 155 is clicked, and then numeric values are inputted serially from the keyboard 71. As a result, the actual package quantities are specified as shown in FIG. 22. Moreover, if an “output freight-prepaid tag” button 159 is clicked, for example, the shipping place code and a shipping instruction numbers are attached to a tag outputting request and the tag outputting request is transmitted from the shipping-place terminal 25 to the shipment-supporting server 19 through the communication line 11.

In Step S350, the shipment-supporting server 19 receives this tag outputting request from the shipping-place terminal 25 through the communication line 11. Thereafter, in Step S360, regarding the shipment pending list data stored in the storage unit 53, the package quantities corresponding to the shipping place code and the shipping instruction numbers attached to the tag outputting request are edited, and tag data equivalent to the package quantities are thereby generated. Then, the generated tag data are stored in the storage unit 55, and further, the tag data equivalent to the package quantities are transmitted to this shipping-place terminal 25.

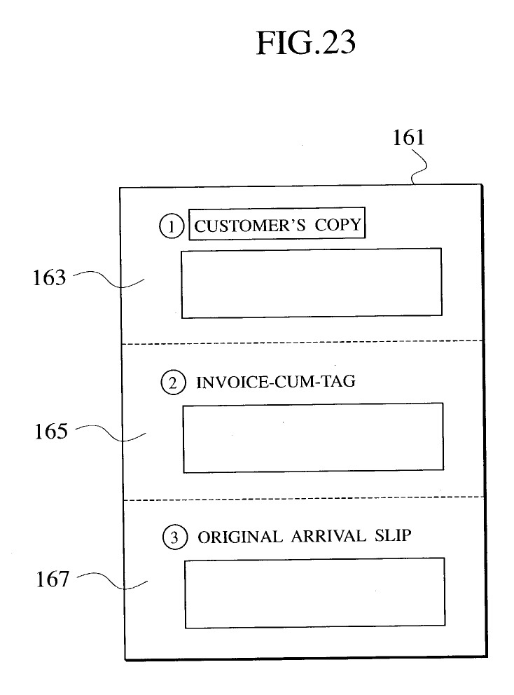

Upon receipt of the tag data equivalent to the package quantities from the shipment-supporting server 19, the shipping-place terminal 25 prints the received tag data with the printer 73. As a result, as shown in FIG. 23 to FIG. 26, tags 161 are printed out of the printer 73.

FIG. 23 is a view showing an entire constitution of the tag 161 printed out of the printer 73. For example, an A4-type cut sheet provided with perforations at boundary parts is usable. Here, from top to bottom, printed thereon are (1) a customer's copy 163, (2) an invoice-cum-tag 165, and (3) an original arrival slip 167, which are of approximately the same dimensions. In particular, this tag 161 is applied to the case when the shipping place is located in a different remote place as against the shopkeeper as shown in FIG. 1.

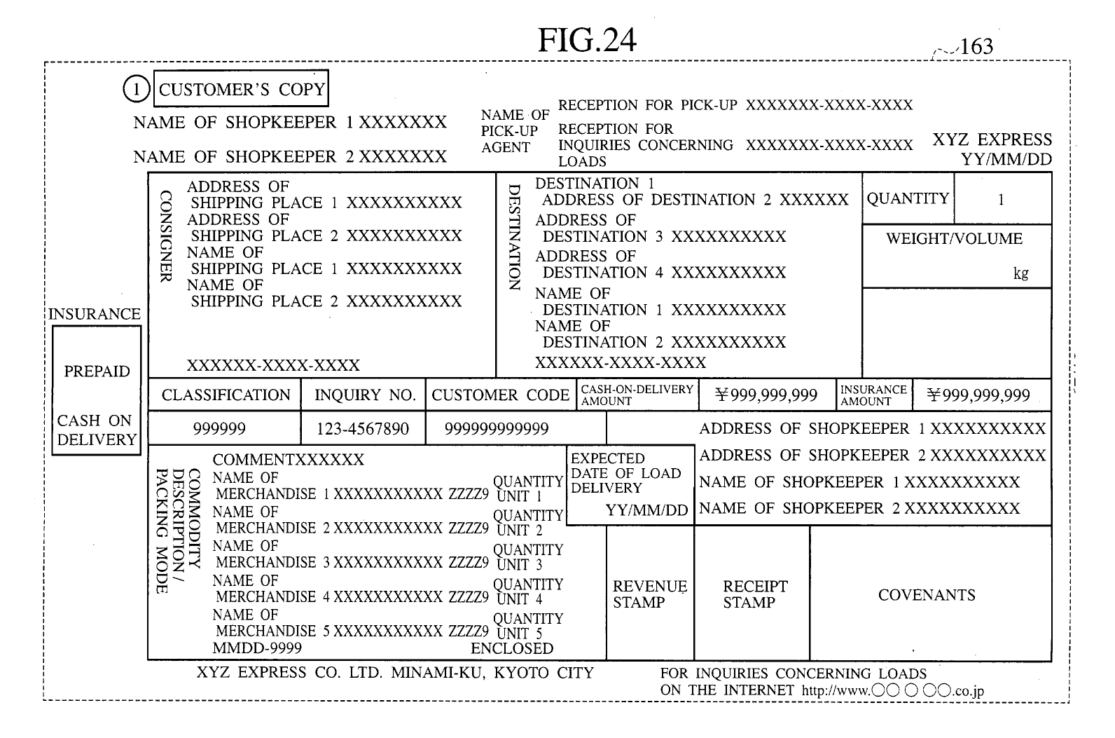

To be more precise, as shown in FIG. 24, a name of a pick-up agent, telephone numbers for reception for pick-up and reception for inquiries concerning loads, date, insurance, a remark indicating freight prepaid and cash-on-delivery merchandise, a name and an address of a home delivery contractor, a URL address as reception for inquires concerning loads on the Internet, and the like are written outside a ruled frame on (1) the customer's copy 163.

Moreover, an address, a name and a telephone number of a shipping place as a consigner, an address, a name and a telephone numbers of a destination, and quantity, weight and volume of the load are written on an upper level inside the ruled frame. Classification, an inquiry number, a customer code, a cash-on-delivery amount, an insurance amount, and an address, a name and a telephone number of a shopkeeper are written on the next level. A comment, names of the merchandise and quantity units collectively as commodity description/packing mode, expected date of delivery, a stamp area, a receipt stamp area, contents of covenants, and the like are written on the bottom level. Note that the home delivery contractor imprints a receipt stamp on (1) the customer's copy 163 at the time point of receiving the load from the shipping place, and returns (1) the customer's copy to the consigner.

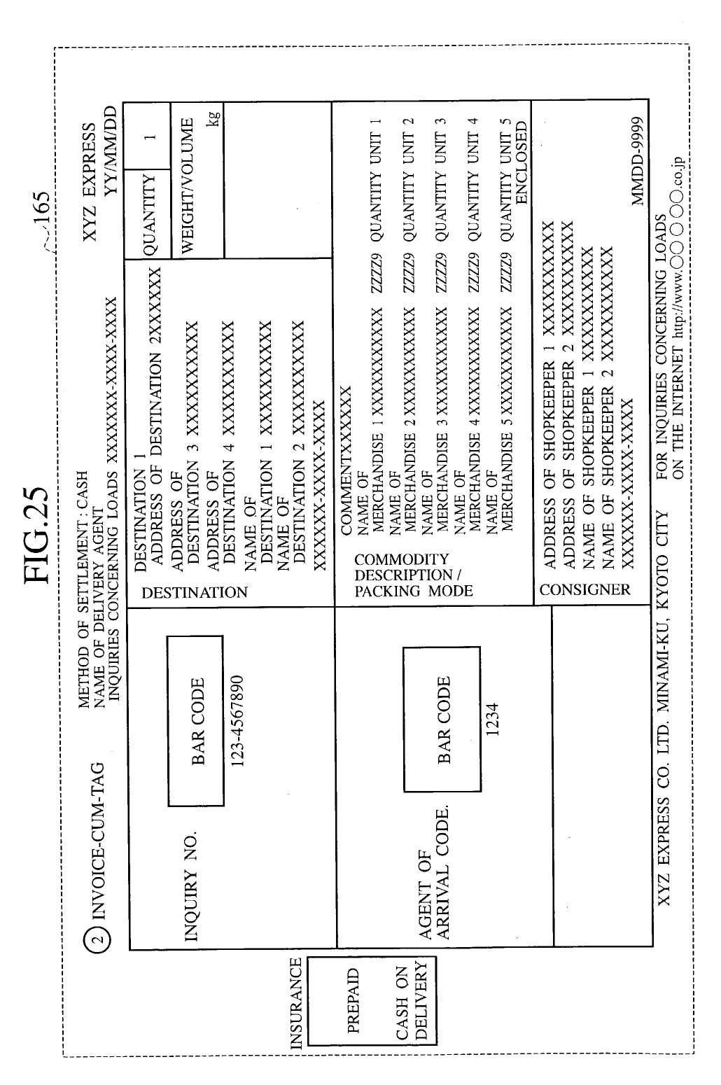

As shown in FIG. 25, a method of settlement, the name of the pick-up agent, the telephone number for reception for inquiries concerning loads, the date, the insurance, the remark indicating freight prepaid and cash-on-delivery merchandise, the name and address of the home delivery contractor, the URL address as reception for inquiries concerning loads on the Internet, and the like are written outside a ruled frame on (2) the invoice-cum-tag 165.

Moreover, a bar code representing the inquiry number and a bar code representing an agent-of-arrival code are written on levels on the left inside the ruled frame. The address, the name and the telephone number of the destination, the quantity, the weight and the volume of the load, the comment, the names of the merchandise and the quantity units collectively as the commodity description/packing mode, the address, the name and the telephone number of the shopkeeper as the consigner, and the like are written on levels on the right.

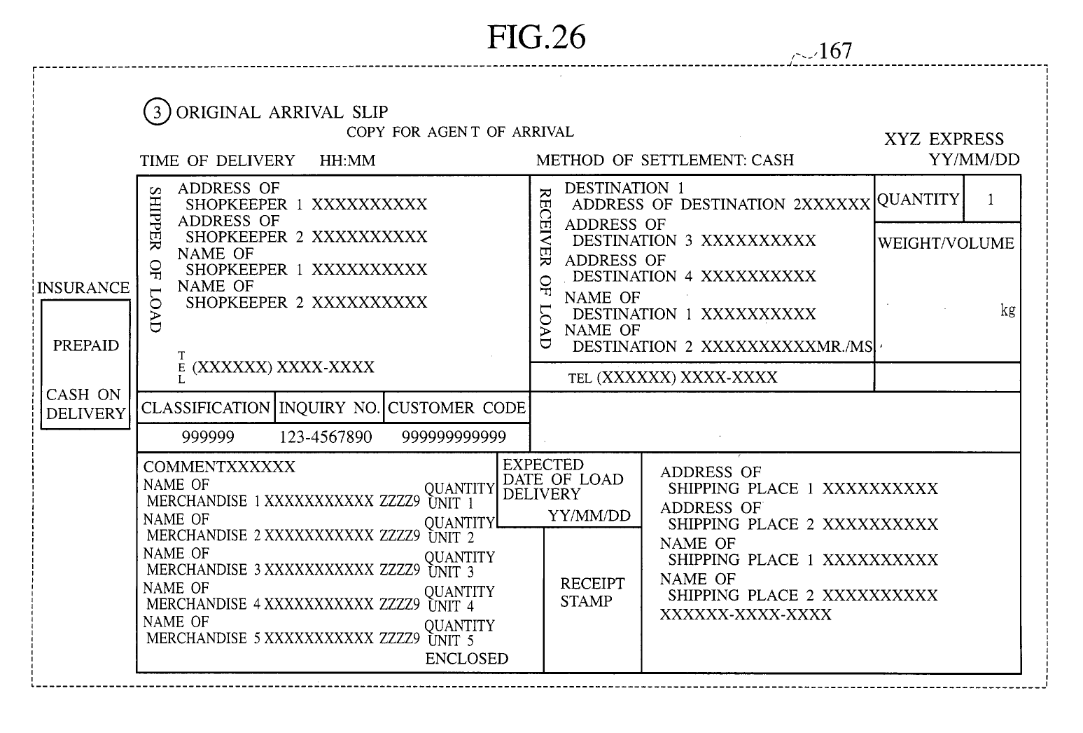

As shown in FIG. 26, delivery time (hh:mm), the method of settlement, the date, the insurance, the remark indicating freight prepaid and cash-on-delivery merchandise, and the name of the home delivery contractor are written outside a ruled frame on (3) the original arrival slip 167.

Moreover, the address, the name and the telephone number of the shopkeeper as a sender of the load, the address, the name and the telephone number of the destination as a receiver of the load, and the quantity, the weight and the volume of the load are written on an upper level inside the ruled frame. The classification, the inquiry number, and the customer code are written on the next level. The comment, the names of the merchandise and the quantity units collectively as the commodity description/packing mode, the expected date of delivery, a receipt stamp area, the address, the name and the telephone number of the shipping place, and the like are written on the bottom level.

As described above, since the tag composed of the customer's copy, the invoice-cum-tag, and the original arrival slip is printed with the shipping-place terminal based on the tag data received from the shipment-supporting server 19, it is possible to curtail a conventional operation of producing a tag at a shipping place.

Thereafter, the shipper receives the tags 161 printed out of the printer 73, which are equivalent to the number of the packages, and attaches the tags to the loads.

As described above, since the tags can be printed in the necessary number in accordance with the number of the packages, it is possible to attach the tags to the individual loads in just proportion, respectively.

Next, since shipment of the relevant load is determined, the shipper moves the cursor and clicks a “determine shipment” button 169 which is displayed on the display screen 145 on the display unit as shown in FIG. 19. As a result, shipment determination information with attachment of the shipping place code and the shipping instruction number is transmitted from the shipping-place terminal 25 to the shipment-supporting server 19 through the communication line 11.

In Step S370, the shipment-supporting server 19 receives this shipment determination information from the shipping-place terminal 25 through the communication line 11. Thereafter, in Step S380, the shipment-supporting server 19 reads the shipping instruction pending list data corresponding to the shipping place code and the shipping instruction number, which are attached to the shipment determination information received from the shipping-place terminal 25, out of the storage unit 53. Then, the shipment-supporting server 19 updates information representing the determination of shipment as determination information.

Here, the shipper cuts (1) the customer's copy 163 from the printed tag 161 and stores (1) the customer's copy 163 in an administrative file, for example. Then, (2) the invoice-cum-tag 165 and (3) the original arrival slip 167 are folded in two, for example, and are inserted into a windowed envelope so that (2) the invoice-cum tag 165 comes out on the front, thus the tag is arranged. Then, this tag is subjected to picking and then attached to the packaged merchandise, and the merchandise is passed to the home delivery contractor.

The home delivery contractor make reference to the tag attached to the merchandise, delivers the merchandise to the destination, and then cuts (3) the original arrival slip 167 from the tag and passes the merchandise to the destination. Thereafter, the home delivery contractor receives the receipt stamp from the destination onto (3) the original arrival slip 167, and stores (3) the original arrival slip 167 in an administrative file as a copy for an agent of arrival in the interest of the home delivery contractor.

As described above, the address and the name of the shopkeeper as the consignee, and the like are written on (2) the invoice-cum-tag 165 to be passed to the destination. For this reason, even if the shopkeeper and the shipping place are different, the shipping place of the merchandise is not informed. Accordingly, it is possible to prevent unnecessary confusion at the destination incurred by description of the shipping place which is different from the shopkeeper.

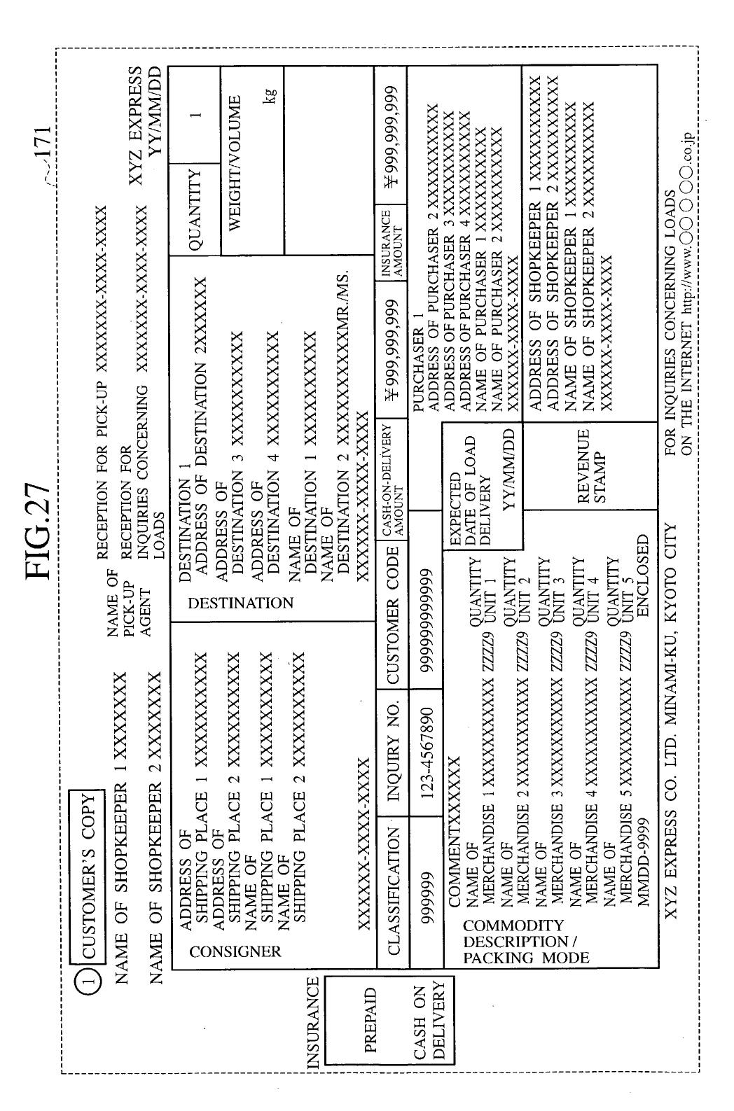

Next, FIG. 27 to FIG. 29 show various parts of another type of a tag to be printed out of the printer 73, which are illustrated in the order of (1) a customer's copy 171, (2) an invoice-cum-tag 173, and (3) an original arrival slip 175. In particular, this tag 171 is applied to the case when the shipping place is located in a different remote place as against the shopkeeper as shown in FIG. 1, and in the case when the merchandise is a gift.

To be more precise, as shown in FIG. 27, a name of a pick-up agent, telephone numbers for reception for pick-up and reception for inquiries concerning loads, date, insurance, a remark indicating freight prepaid and cash-on-delivery merchandise, a name and an address of a home delivery contractor, a URL address as reception for inquires concerning loads on the Internet, and the like are written outside a ruled frame on (1) the customer's copy 171.

Moreover, an address, a name and a telephone number of a shipping place as a consigner, an address, a name and a telephone number of a destination, and quantity, weight and volume of the load are written on an upper level inside the ruled frame. Classification, an inquiry number, a customer code, a cash-on-delivery amount, an insurance amount, and an address, a name and a telephone number of a purchaser are written on the next level. A comment, names of the merchandise and quantity units collectively as commodity description/packing mode, expected date of delivery, a stamp area, a receipt stamp area, and an address, a name and a telephone number of a shopkeeper are written on the bottom level.

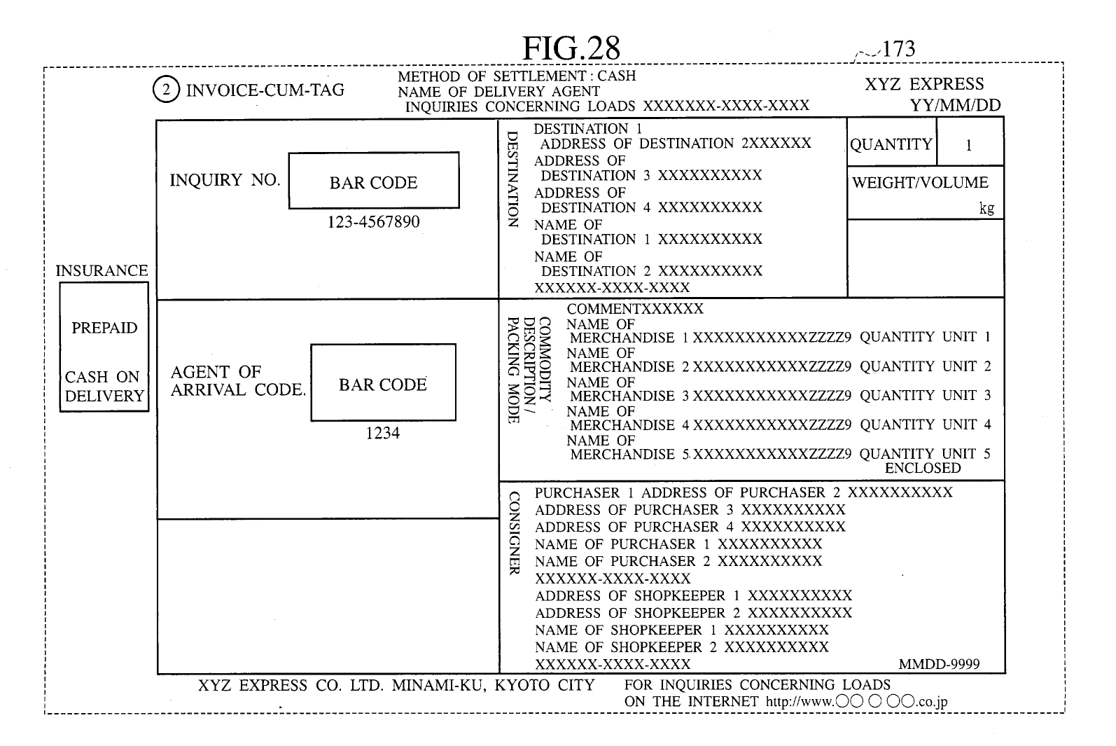

As shown in FIG. 28, a method of settlement, the name of the pick-up agent, the telephone number for reception for inquiries concerning loads, the date, the insurance, the remark indicating freight prepaid and cash-on-delivery merchandise, the name and address of the home delivery contractor, the URL address as reception for inquiries concerning loads on the Internet, and the like are written outside a ruled frame on (2) the invoice-cum-tag 173.

Moreover, a bar code representing the inquiry number and a bar code representing an agent-of-arrival code are written on levels on the left inside the ruled frame. The address, the name and the telephone number of the destination, the quantity, the weight and the volume of the load, the comment, the names of the merchandise and the quantity units collectively as the commodity description/packing mode, the address, the name and the telephone number of the purchaser as the consigner, the address, the name and the telephone number of the shopkeeper, and the like are written on levels on the right.

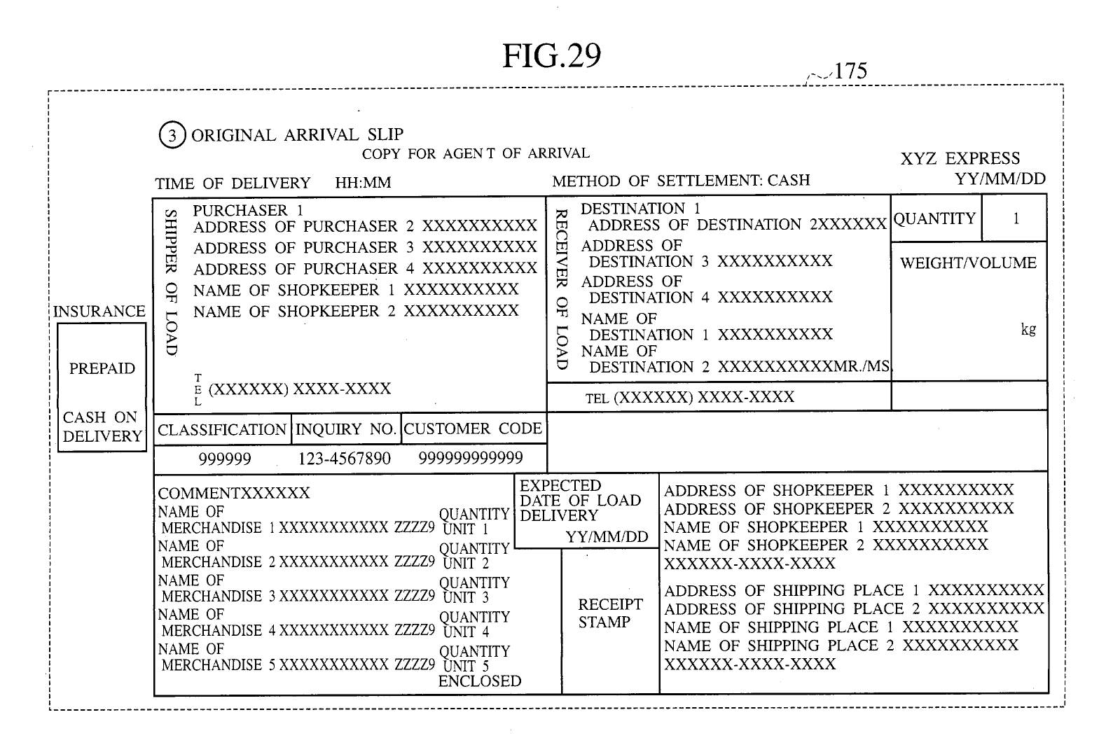

As shown in FIG. 29, delivery time (hh:mm), the method of settlement, the date, the insurance, the remark indicating freight prepaid and cash-on-delivery merchandise, and the name of the home delivery contractor are written outside a ruled frame on (3) the original arrival slip 175.

Moreover, the address, the name and the telephone number of the shopkeeper as a sender of the load, the address, the names and the telephone number of the destination as a receiver of the load, and the quantity, the weight and the volume of the load are written on an upper level inside the ruled frame. The classification, the inquiry number, and the customer code are written on the next level. The comment, the names of the merchandise and the quantity units collectively as the commodity description/packing mode, the expected date of delivery, a receipt stamp area, the address, the name and the telephone number of the shipping place, and the like are written on the bottom level.

As described above, since the tag composed of the customer's copy, the invoice-cum-tag, and the original arrival slip is printed with the shipping-place terminal based on the tag data received from the shipment-supporting server 19, it is possible to curtail a conventional operation of producing a tag at a shipping place.

As described above, the address and the name of the purchaser, and the address and the name of the shopkeepers, and the like are written collectively as the consigners on (2) the invoice-cum-tag 173 to be passed to the destination, and the purchaser and the shopkeeper are written down as the consigners of the load in the case when the merchandise is a gift. For this reason, the destination of the merchandise can confirm the purchaser.

Moreover, since the shipping place of the merchandise is not informed therein, it is possible to prevent unnecessary confusion at the destination incurred by description of the shipping place which is different from the shopkeeper.

As an effect concerning the first embodiment of the present invention, when the order-accepting server accepts the order information from the purchaser regarding the merchandise presented to a shop in the Internet shopping mall, merchandise picking is performed with reference to the shipping instruction list at the shipping place which is distant from the shopkeeper, based on the order information accepted by the order-accepting server. Then, it is possible to attach the tag to the merchandise as the load for shipment. As a result, it is possible to shorten the operation steps from acceptance of the order information by the order-accepting server to shipment of the merchandise, and to reduce operation time as well.

Moreover, since the shipment units can be changed depending on the pieces of the merchandise at the shopkeeper terminal, it is possible to specify refrigerated deliveries and ordinary deliveries, for example, depending on the pieces of the merchandise upon ordering transport to the destination.

In addition, since the detail points on the transport information and the shipping-place information can be inputted for change from the shopkeeper terminal, it is possible to specify the transport information and the shipping-place information so as to meet the requests from the shopkeeper. Then, it is possible to conduct the operation at the shipping place based on the transport information and the shipping-place information.

Furthermore, since the tags can be printed in the necessary number in accordance with the number of the packages packed at the shipping place, and the tags can be thereby attached to the individual loads in just proportion, respectively.

(Second Embodiment)

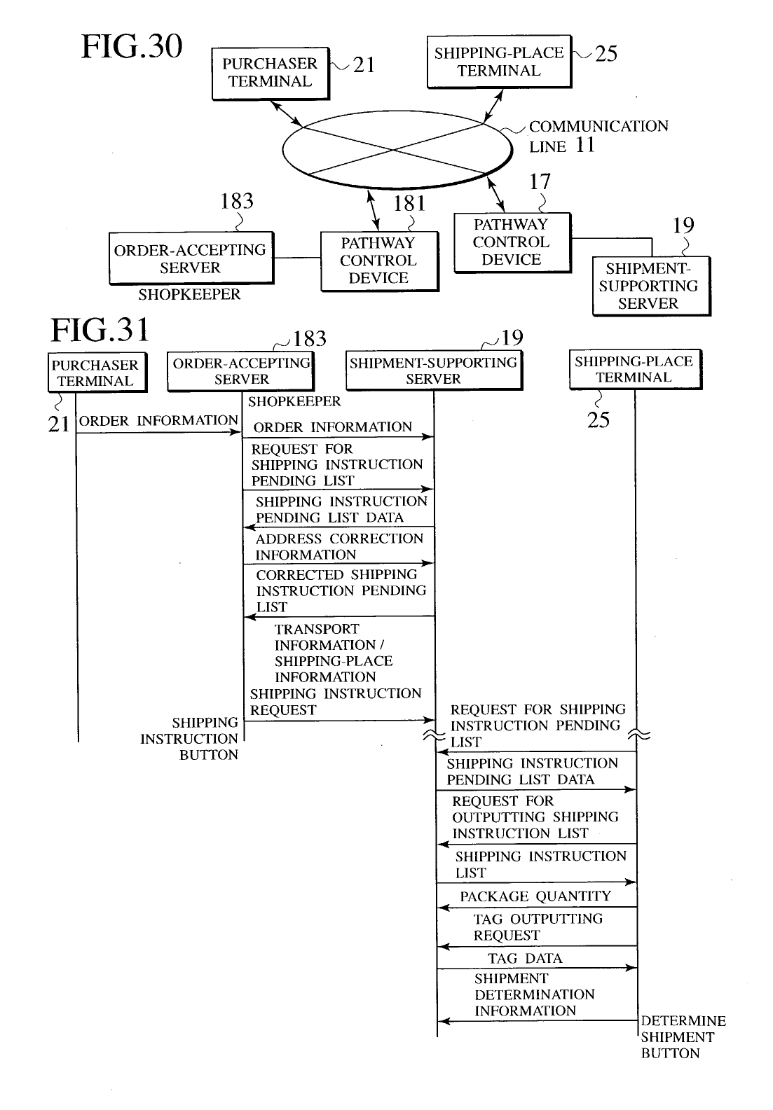

FIG. 30 shows a system configuration of a shipment-supporting system according to a second embodiment of the present invention.

As shown in FIG. 30, to a communication line 11 composed of telephone lines and the Internet, connected are: pathway control devices 181 and 17 which exchange pathway information with the communication line 11 so as to select the most appropriate pathway automatically; an order-accepting server 183 installed at a home of a shopkeeper individual or at a shopkeeper company who presents the merchandise, which is connected through the pathway control device 181 and accepts order information from a purchaser of merchandise presented to a shop in a shopping mall on the Internet, for example; a shipment-supporting server 19 which is installed at a home delivery contractor connected through the pathway control device 17; a purchaser terminal 21 installed at a home of the purchaser; and a shipping-place terminal 25 installed at a shipping place for shipping the merchandise.

This embodiment is characterized in that the shopkeeper terminal as shown in the first embodiment is integrated with the order-accepting server.

Next, FIG. 31 is a view for explaining operations of the shipment-supporting system according to the second embodiment of the present invention. A sequence chart shown in FIG. 31 is characterized in that the shopkeeper terminal 23 is deleted from the sequence chart shown in FIG. 9. Moreover, the shipment-supporting server 19 operates in accordance with the flowcharts shown in FIG. 6 to FIG. 8.

Note that the order-accepting server is provided separately from the shopkeeper terminal in the first embodiment. However, in the second embodiment, the both constituents are combined in one constituent to be connected to the communication line 11; therefore, description regarding the operation of the shipment-supporting server 19 shown in FIG. 6 to FIG. 8 will be omitted herein.

As an effect concerning the second embodiment of the present invention, when the shopkeeper owns the order-accepting server and the order-accepting server accepts the order information from the purchaser regarding the merchandise presented to a shop in the Internet shopping mall, merchandise picking is performed with reference to the shipping instruction list at the shipping place which is distant from the shopkeeper, based on the order information accepted by the order-accepting server of the shopkeeper. Then, it is possible to attach the tag to the merchandise as the load for shipment. As a result, it is possible to shorten the operation steps from acceptance of the order information by the order-accepting server of the shopkeeper to shipment of the merchandise, and to reduce operation time as well.

Moreover, since the shipment units can be changed depending on the pieces of the merchandise at the order-accepting server of the shopkeeper, it is possible to specify refrigerated deliveries and ordinary deliveries, for example, depending on the pieces of the merchandise upon ordering transport to the destination.

In addition, since the detail points on the transport information and the shipping-place information can be inputted for change from the order-accepting server of the shopkeeper, it is possible to specify the transport information and the shipping-place information so as to meet the requests from the shopkeeper. Then, it is possible to conduct the operation at the shipping place based on this information.

Furthermore, since the tags can be printed in the necessary number in accordance with the number of the packages packed at the shipping place, and the tags can be thereby attached to the individual loads in just proportion, respectively.

(Third Embodiment)

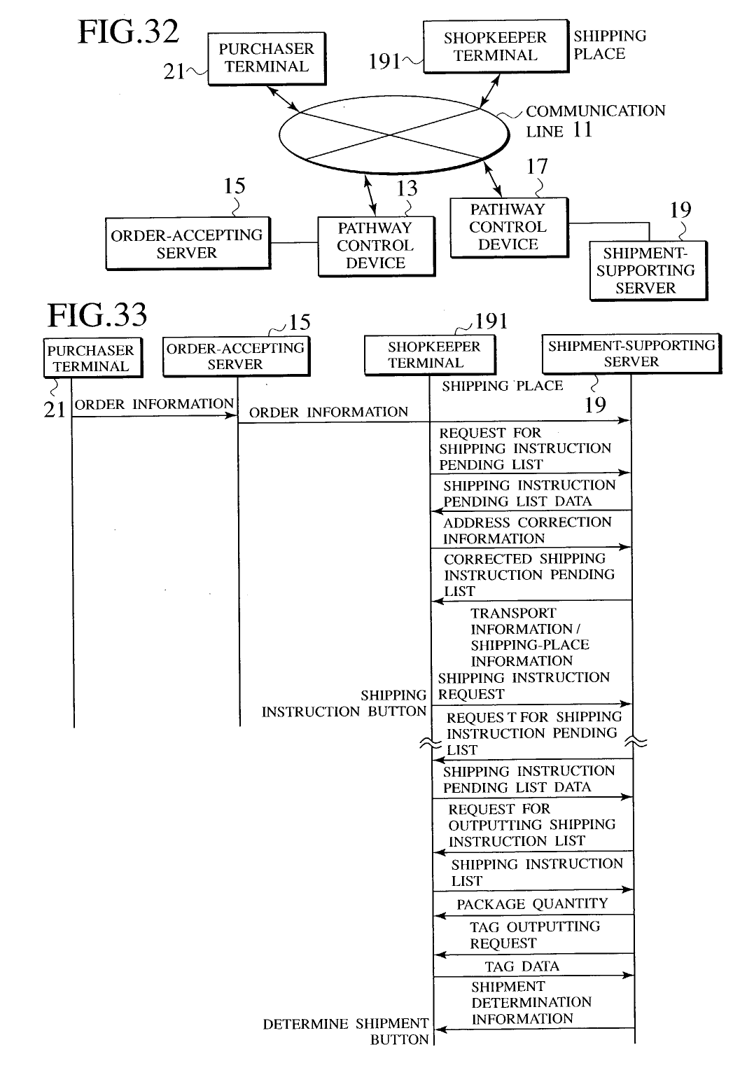

FIG. 32 shows a system configuration of a shipment-supporting system according to a third embodiment of the present invention.

As shown in FIG. 32, to a communication line 11 composed of telephone lines and the Internet, connected are: pathway control devices 13 and 17 which exchange pathway information with the communication line 11 so as to select the most appropriate pathway automatically; an order-accepting server 15 which is connected through the pathway control device 13 and accepts order information from a purchaser of merchandise presented to a shop in a shopping mall on the Internet, for example; a shipment-supporting server 19 which is installed at a home delivery contractor connected through the pathway control device 17; a purchaser terminal 21 installed at a home of the purchaser; and a shopkeeper terminal 191 installed at a shopkeeper-shipping place for presenting the merchandise and shipping the merchandise.

This embodiment is characterized in that the shipping-place terminal as shown in the first embodiment is integrated with the shopkeeper terminal.

Next, FIG. 33 is a sequence chart for explaining operations of the shipment-supporting system according to the third embodiment of the present invention. This sequence chart is characterized in that the shopkeeper terminal 23 also serves as the shipping-place terminal 25 in contrast to the sequence chart shown in FIG. 9. Moreover, the shipment-supporting server 19 operates in accordance with the flowcharts shown in FIG. 6 to FIG. 8.

Note that the shopkeeper terminal is provided separately from the shipping-place terminal in the first embodiment. However, in the third embodiment, the both constituents are combined in one constituent to be connected to the communication line 11; therefore, description regarding the operation of the shipment-supporting server 19 shown in FIG. 6 to FIG. 8 will be omitted herein.

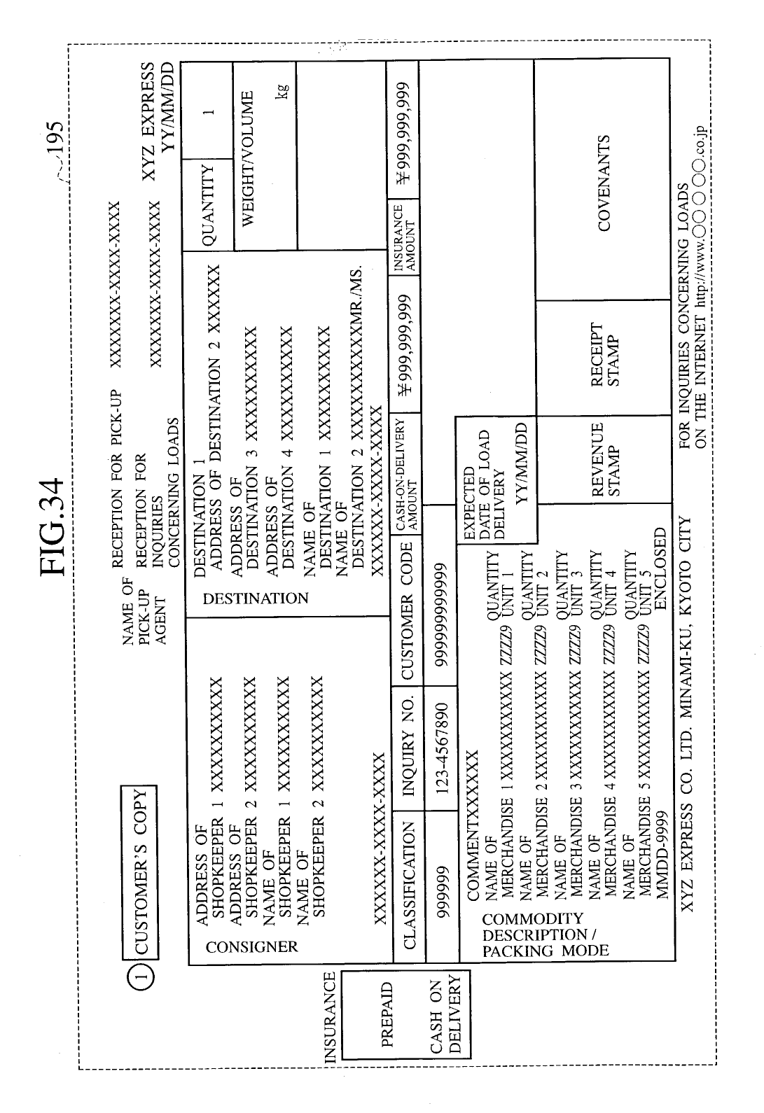

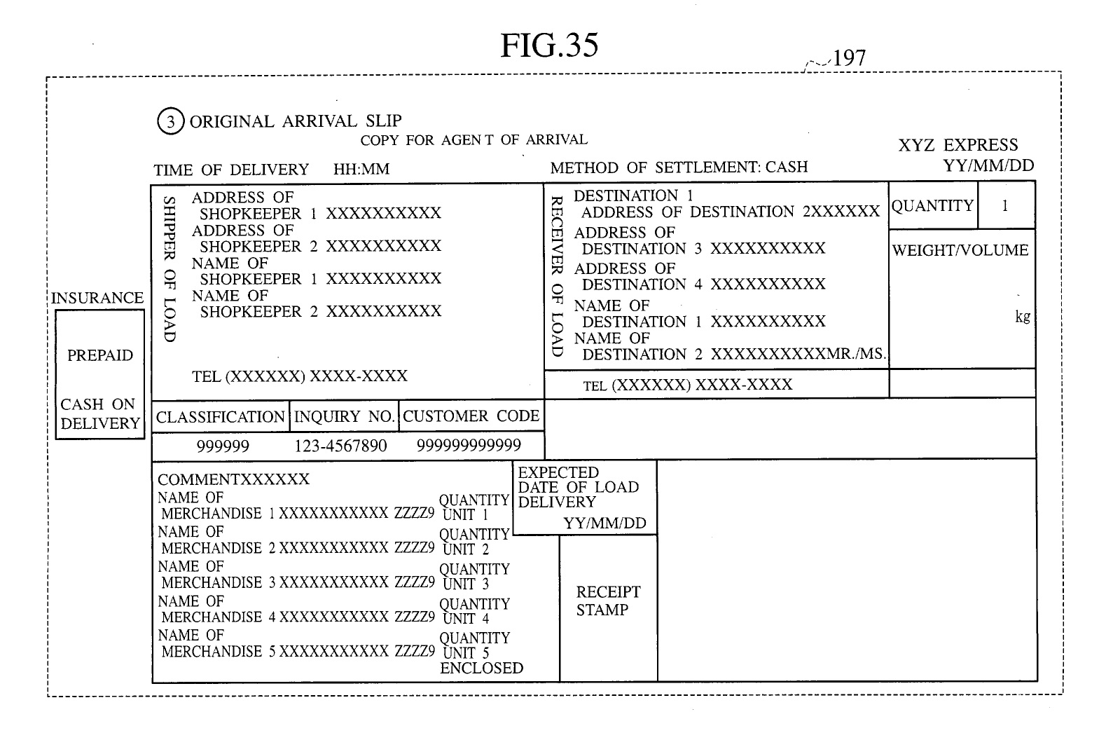

Next, FIG. 34 and FIG. 35 are views showing various parts of another type of tag to be printed out of the printer 73, which are illustrated in the order of (1) a customer's copy 171 and (3) an original arrival slip 175. Since an invoice-cum-tag herein is similar to (2) the invoice-cum-tag 165 shown in FIG. 25, description thereof will be omitted.

This tag is applied to the case where the shopkeeper also serves as the shipping place as shown in FIG. 32 in the embodiment.

To be more precise, as shown in FIG. 34, a name of a pick-up agent, telephone numbers for reception for pick-up and reception for inquiries concerning loads, date, insurance, a remark indicating freight prepaid and cash-on-delivery merchandise, a name and an address of a home delivery contractor, a URL address as reception for inquires concerning loads on the Internet, and the like are written outside a ruled frame on (1) the customer's copy 195.

Moreover, an address, a name and a telephone number of a shopkeeper as a consigner, an address, a name and a telephone number of a destination, and quantity, weight and volume of the load are written on an upper level inside the ruled frame. Classification, an inquiry number, a customer code, a cash-on-delivery amount, and an insurance amount are written on the next level. A comment, names of the merchandise and quantity units collectively as commodity description/packing mode, expected date of delivery, a revenue stamp area, a receipt stamp area, a receipt stamp area, contents of covenants, and the like are written on the bottom level.

As shown in FIG. 35, delivery time (hh:mm), a method of settlement, the date, the insurance, the remark indicating freight prepaid and cash-on-delivery merchandise, and the name of the home delivery contractor are written outside a ruled frame on (3) the original arrival slip 197.

Moreover, the address, the name and the telephone number of the shopkeeper as a sender of the load, the address, the name and the telephone number of the destination as a receiver of the load, and the quantity, the weight and the volume of the load are written on an upper level inside the ruled frame. The classification, the inquiry number, and the customer code are written on the next level. The comment, the names of the merchandise and the quantity units collectively as the commodity description/packing mode, the expected date of delivery, a receipt stamp area, and the like are written on the bottom level.

As described above, since the tag composed of the customer's copy, the invoice-cum-tag, and the original arrival slip is printed with the shipping-place terminal based on the tag data received from the shipment-supporting server 19, it is possible to curtail a conventional operation of producing a tag at a shipping place.

As described above, the address and the name of the purchaser, and the address and the name of the shopkeeper, and the like are written collectively as the consigners on (2) the invoice-cum-tag to be passed to the destination, and the purchaser and the shopkeeper are written down as the consigners of the load in the case when the merchandise is a gift. Accordingly, the destination of the merchandise can confirm the purchaser.

Moreover, since the shipping place of the merchandise is not informed therein, it is possible to prevent unnecessary confusion at the destination incurred by description of the shipping place which is different from the shopkeeper.

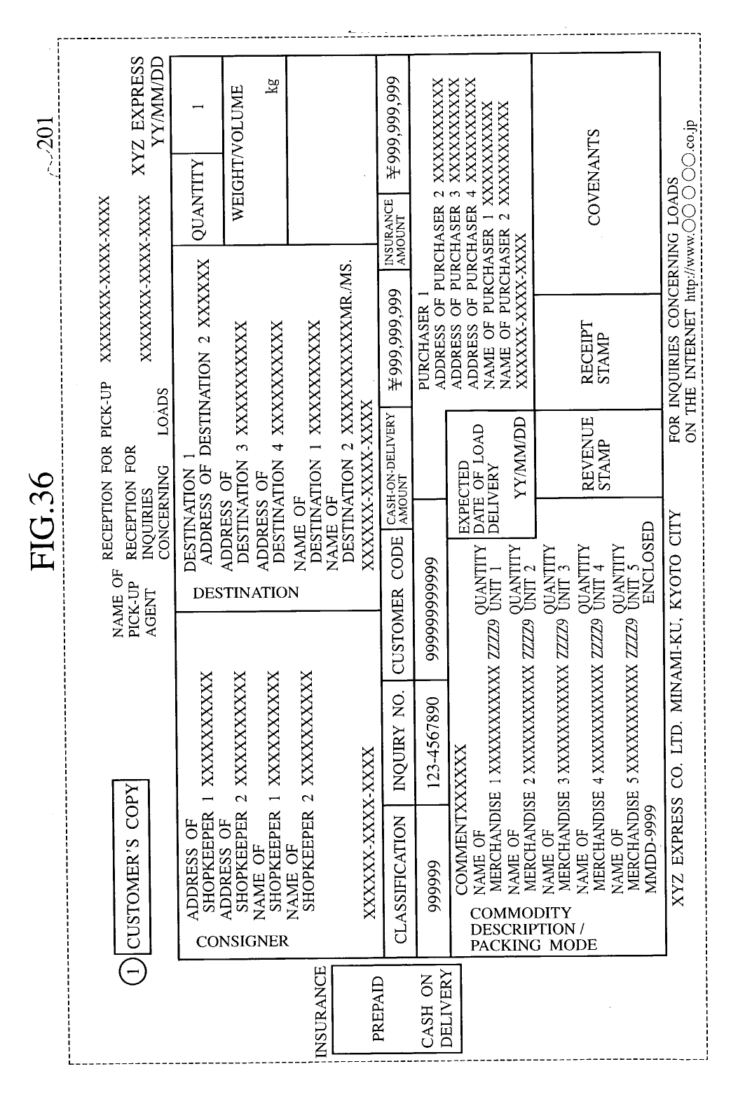

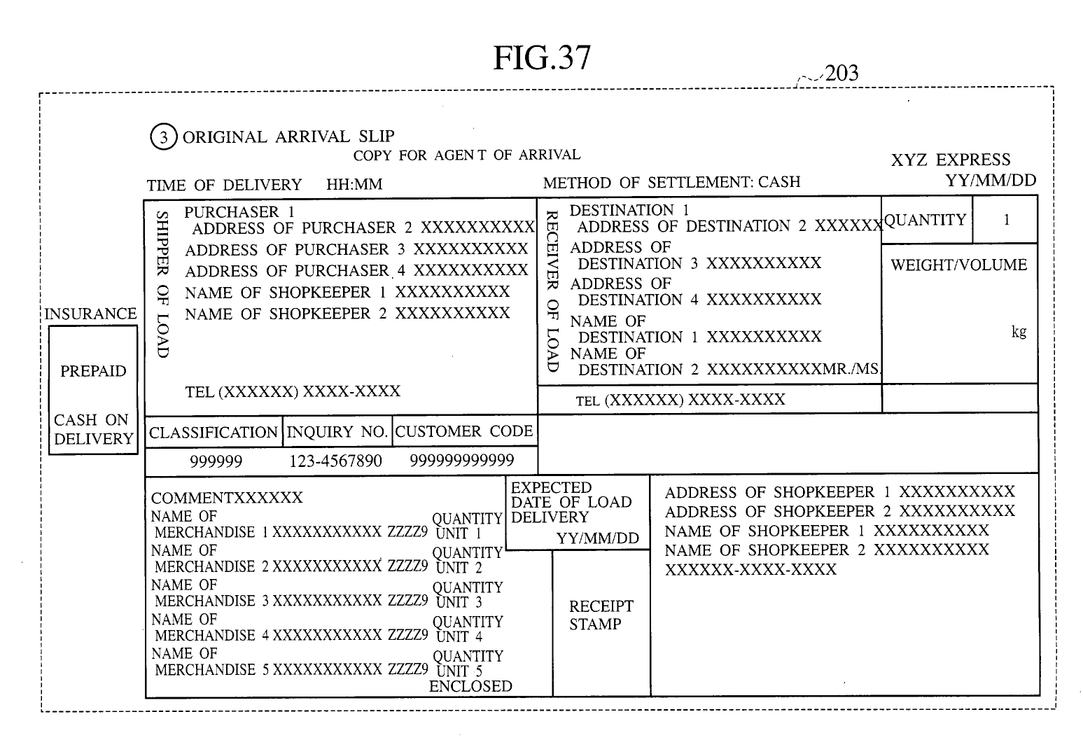

Next, FIG. 36 and FIG. 37 are views showing various parts of another type of tag to be printed out of the printer 73, which are illustrated in the order of (1) a customer's copy 201 and (3) an original arrival slip 203.

In this embodiment, this tag is applied to the case where the shopkeeper also serves as the shipping place as shown in FIG. 32 and in the case when the merchandise is a gift. Since an invoice-cum-tag herein is similar to (2) the invoice-cum-tag 173 shown in FIG. 28, description thereof will be omitted.

To be more precise, as shown in FIG. 36, a name of a pick-up agent, telephone numbers for reception for pick-up and reception for inquiries concerning loads, date, insurance, a remark indicating freight prepaid and cash-on-delivery merchandise, a name and an address of a home delivery contractor, a URL address as reception for inquires concerning loads on the Internet, and the like are written outside a ruled frame on (1) the customer's copy 201.

Moreover, an address, a name and a telephone number of a shopkeeper as a consigner, an address, a name and a telephone number of a destination, quantity, weight and volume of the load, and an address, a name and a telephone number of a purchaser are written on an upper level inside the ruled frame. Classification, an inquiry number, a customer code, a cash-on-delivery amount, and an insurance amount are written on the next level. A comment, names of the merchandise and quantity units collectively as commodity description/packing mode, expected date of delivery, a revenue stamp area, a receipt stamp area, a receipt stamp area, contents of covenants, and the like are written on the bottom level.

As shown in FIG. 37, delivery time (hh:mm), a method of settlement, the date, the insurance, the remark indicating freight prepaid and cash-on-delivery merchandise, and the name of the home delivery contractor are written outside a ruled frame on (3) the original arrival slip 203.

Moreover, the address, the name and the telephone number of the purchaser as a sender of the load, the address, the name and the telephone number of the destination as a receiver of the load, and the quantity, the weight and the volume of the load are written on an upper level inside the ruled frame. The classification, the inquiry number, and the customer code are written on the next level. The comment, the names of the merchandise and the quantity units collectively representing the commodity description/packing mode, the expected date of delivery, a receipt stamp area, the address, the name and the telephone number of the shopkeeper, and the like are written on the bottom level.

As described above, since the tag composed of the customer's copy, the invoice-cum-tag, and the original arrival slip is printed with the shipping-place terminal based on the tag data received from the shipment-supporting server 19, it is possible to curtail a conventional operation of producing a tag at a shipping place.

As described above, the address and the name of the purchaser, and the address and the name of the shopkeeper, and the like are written collectively as the consigners on (2) the invoice-cum-tag to be passed to the destination, and the purchaser and the shopkeeper are written down as the consigners of the load in the case when the shopkeeper and the shipping place are different and in the case when the merchandise is a gift. Accordingly, the destination of the merchandise can confirm the purchaser.

Moreover, since the shipping place of the merchandise is not informed therein, it is possible to prevent unnecessary confusion at the destination incurred by description of the shipping place which is different from the shopkeeper.

As an effect concerning the third embodiment of the present invention, when the order-accepting server accepts the order information from the purchaser regarding the merchandise presented to a shop in the Internet shopping mall in the case where the shopkeeper owns the shipping place, merchandise picking is performed with reference to the shipping instruction list at the shopkeeper-shipping place, based on the order information accepted by the order-accepting server. For this reason, it is possible to attach the tag to the merchandise as the load for shipment. As a result, it is possible to further shorten the operation steps from acceptance of the order information by the order-accepting server of the shopkeeper to shipment of the merchandise, and to further reduce operation time as well.

Moreover, since the shipment units can be changed depending on the pieces of the merchandise from the terminal at the shopkeeper-shipping place, it is possible to specify refrigerated deliveries and ordinary deliveries, for example, depending on the pieces of the merchandise upon ordering transport to the destination.

In addition, since the detail points on the transport information and the shipping-place information can be inputted for change from the terminal at the shopkeeper-shipping place, it is possible to specify the transport information and the shipping-place information so as to meet the requests from the shopkeeper. Then, it is possible to conduct the operation at the shipping place based on the transport information and the shipping-place information.

Furthermore, since the tags can be printed in the necessary number in accordance with the number of the packages packed at the shopkeeper-shipping place, and the tags can be thereby attached to the individual loads in just proportion, respectively.

(Fourth Embodiment)

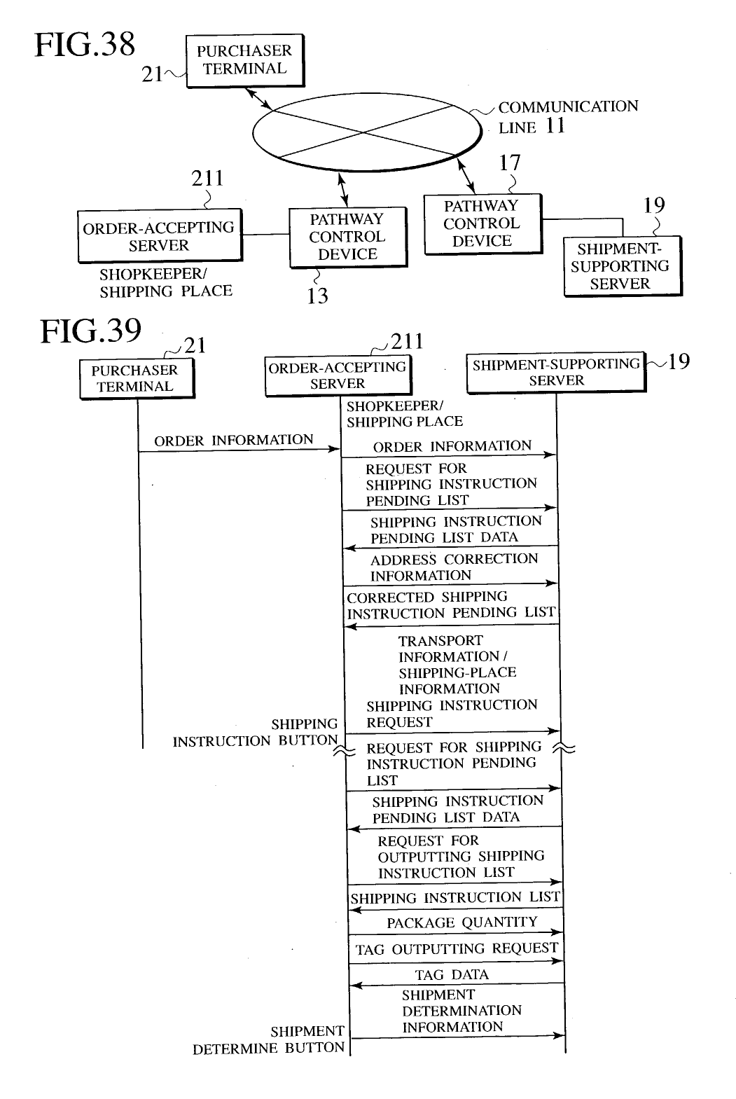

FIG. 38 shows a system configuration of a shipment-supporting system according to a fourth embodiment of the present invention.

As shown in FIG. 38, to a communication line 11 composed of telephone lines and the Internet, connected are: pathway control devices 13 and 17 which exchange pathway information with the communication line 11 so as to select the most appropriate pathway automatically; an order-accepting server 15 which is connected through the pathway control device 13 and accepts order information from a purchaser of merchandise presented to a shop in a shopping mall on the Internet, for example; a shipment-supporting server 19 which is installed at a home delivery contractor connected through the pathway control device 17; and a purchaser terminal 21 installed at a home of the purchaser.

This embodiment is characterized in that the shopkeeper terminal and the shipping-place terminal as shown in the first embodiment are integrated with the order-accepting server 211.

Next, FIG. 39 is a sequence chart for explaining operations of the shipment-supporting system according to the fourth embodiment of the present invention. This sequence chart is characterized by provision of the order-accepting server 211 which also serves as the order-accepting server 15 and the shopkeeper terminal 191 in contrast to the sequence chart shown in FIG. 33. Moreover, the shipment-supporting server 19 operates in accordance with the flowcharts shown in FIG. 6 to FIG. 8.

Note that the order-accepting server, the shopkeeper terminal, and the shipping-place terminal are provided separately in the first embodiment. However, in the fourth embodiment, these three constituents are combined in one constituent to be connected to the communication line 11; therefore, description regarding the operation of the shipment-supporting server 19 shown in FIG. 6 to FIG. 8 will be omitted herein.

As an effect concerning the fourth embodiment of the present invention, when the order-accepting server at the shopkeeper-shipping place accepts the order information from the purchaser regarding the merchandise presented to a shop in the Internet shopping mall in the case where the shopkeeper owns the order-accepting server and the shipping place, merchandise picking is performed with reference to the shipping instruction list at the shopkeeper-shipping place, based on the order information accepted by the order-accepting server at the shopkeeper-shipping place. For this reason, it is possible to attach the tag to the merchandise as the load for shipment. As a result, it is possible to further shorten the operation steps from acceptance of the order information by the order-accepting server at the shopkeeper-shipping place to shipment of the merchandise, and to further reduce operation time as well.

Moreover, since the shipment units can be changed depending on the pieces of the merchandise from the order-accepting server at the shopkeeper-shipping place, it is possible to specify refrigerated deliveries and ordinary deliveries, for example, depending on the pieces of the merchandise upon ordering transport to the destination.

In addition, since the detail points on the transport information and the shipping-place information can be inputted for change from the order-accepting server at the shopkeeper-shipping place, it is possible to specify the transport information and the shipping-place information so as to meet the requests from the shopkeeper. Then, it is possible to conduct the operation at the shipping place based on this information.

Furthermore, since the tags can be printed in the necessary number in accordance with the number of the packages packed at the shopkeeper-shipping place, and the tags can be thereby attached to the individual loads in just proportion, respectively.

### INDUSTRIAL APPLICABILITY

According to the present invention, when an order-accepting server accepts order information from a purchaser regarding merchandise presented to a shop in a virtual shopping mall, a shipment-supporting server generates a shipping instruction pending list, which represents an uninstructed state of shipment of the merchandise, based on the order information from the order-accepting server, and transmits the shipping instruction pending list to a shopkeeper terminal. Then, the shopkeeper terminal generates transport information, shipping-place information, and a shipping instruction request for shipping the merchandise based on the received shipping instruction pending list, and transmits the transport information, the shipping-place information and the shipping instruction request to the shipment-supporting server. The shipment-supporting server generates a shipment pending list, which represents unshipped merchandise depending on each shipping place, based on the received transport information, the shipping-place information and the shipping instruction request, and then transmits the shipment pending list to the terminal of each shipping place. Thereafter, the shipping-place terminal displays the received shipment pending list, and then transmits a request for shipping instruction information concerning the unshipped merchandise to the shipment-supporting server. Moreover, the shipmen-supporting server generates a shipping instruction list and tag data in response to the received request for shipping instruction information, and transmits the shipping instruction list and the tag data to the shipping-place terminal. Next the shipping-place terminal prints the shipping instruction list and the tag data thus received. As a result, merchandise picking is performed with reference to the shipping instruction list at the shipping place which is distant from the shopkeeper, based on the order information accepted by the order-accepting server. Accordingly, it is possible to attach the tag to the merchandise as the load for shipment.

As a result, it is possible to shorten operation steps from acceptance of the order information by the order-accepting server to shipment of the merchandise, and to reduce operation time as well.

As described above, the present invention is useful in the event of accepting order information from a purchaser of merchandise presented to a shop in a virtual shopping mall and thereby supporting shipment of the merchandise. In particular, the present invention is suitable for shortening of operation steps from acceptance of the order information to shipment of the merchandise, and for reduction of operation time therein.

1. (Amended) A shipment-supporting method for a virtual shopping mall having an order-accepting server for receiving order information from a purchaser of merchandise presented to a shop in a virtual shopping mall, a shopkeeper terminal who presents the merchandise, a shipping-place terminal where the merchandise is shipped from, and a shipment-supporting server for performing information communication between the shopkeeper terminal and the shopping-place terminal through a communication line and supporting shipment of the merchandise for which the order-accepting server accepted an order, wherein
the shipment-supporting server generates a shipping instruction pending list, which shows the state where shipment of the merchandise is not instructed yet, based on the received order information, and transmits the shipping instruction pending list to the shopkeeper terminal;
the shopkeeper terminal generates transport information and shipping place information for shipping the merchandise, and a shipping instruction request based on the received shipping instruction pending list and transmits the transport information, the shipping place information, and the shipping instruction request to the shipment-supporting server;
the shipment-supporting server generates a shipment pending list, which represents the unshipped merchandise depending on each shipping place, based on the received transport information, the shipping place information, and the shipping instruction request, and transmits the shipment pending list to each shipping-place terminal;
the shipping-place terminal displays the received shipment pending list and transmits a request for shipping instruction information concerning this unshipped merchandise to the shipment-supporting server;
the shipment-supporting server generates a shipping instruction list and tag data which includes invoice-cum tag arranged to include description regarding the shopkeeper at least but exclude description regarding the shipping place in response to the received request for shipping instruction information, and transmits the shipping instruction list and the tag data to the shipping-place terminal; and
the shipping-place terminal prints out the received shipping instruction list and the tag data.

2. The shipment-supporting method for a virtual mall of claim 1,
wherein the shipment-supporting server urges the shopkeeper terminal to input a change in a shipment unit of the merchandise, and transmits the shipment unit of the merchandise received from the shopkeeper terminal to the shipping-place terminal.

3. The shipment-supporting method for a virtual mall of claim 1,
wherein the shipment-supporting server urges the shopkeeper terminal to input a change in the transport information and/or the shipping place information of the merchandise, and transmits the transport information and/or the shipping place information of the merchandise which is received from the shopkeeper terminal to the shipping-place terminal.

4. The shipment-supporting method for a virtual mall of claim 1,
wherein the shipment-supporting server urges the shipping-place terminal to input a quantity of packages of the merchandise, and generates the tag data based on the quantity of packages of the merchandise received from the shipping-place terminal.

5. The shipment-supporting method for a virtual mall of claim 1,
wherein the shopkeeper terminal is integrated with the order-accepting server.

6. The shipment-supporting method for a virtual mall of claim 1,
wherein the shipping-place terminal is integrated with the shopkeeper terminal.

7. The shipment-supporting method for a virtual mall of claim 1,
wherein the shopkeeper terminal and the shipping-place terminal are integrated with the order-accepting server.

8. (Added) The shipment-supporting method for a virtual mall of claim 1,
wherein the shipping-place terminal includes description regarding the purchaser in the invoice-cum tag included in the tag data which is going to be printed.
